(19) United States
(12) Patent Application Publication
(10) Pub. No.: US 2026/0245567 A1
(43) Pub. Date: Aug. 20, 2026

(54) MULTI-STAGE VECTOR QUANTIZATION FOR AUDIO CODING

(71) Applicant: Telefonaktiebolaget LM Ericsson (publ), Stockholm (SE)

(72) Inventor: Jonas SVEDBERG, UPPSALA (SE)

(73) Assignee: Telefonaktiebolaget LM Ericsson (publ), Stockholm (SE)

(21) Appl. No.: 19/159,734

(22) PCT Filed: Feb. 14, 2024
(86) PCT No.: PCT/EP2024/053760

§ 371 Date: Aug. 26, 2025

Related U.S. Application Data
(60) Provisional application No. 63/448,440, filed on Feb. 27, 2023.
(60) Provisional application No. 63/454,166, filed on Mar. 23, 2023.

(51) Int. Cl. G10L 19/02; G10L 19/012; G10L 19/038

(52) U.S. Cl. CPC G10L 19/0212; G10L 19/012; G10L 19/038

(57) ABSTRACT

A method performed by an encoder is disclosed. The method includes obtaining a discrete cosine transform, DCT, target vector; performing a sub-optimal pairwise inner search in each segment of a codebook having a plurality of segments with each segment having truncated vectors different from truncated vectors of other segments of the plurality of segments to determine, from each of the plurality of segments, a pairwise initial candidate set to form a plurality of pairwise initial candidates from the sub-optimal pairwise inner searches, wherein the DCT target vector is a target of the sub-optimal pairwise inner search in each of the plurality of segments; reconstructing the plurality of final candidates using an inverse type II discrete cosine transform, DCT-II, to transform the plurality of final candidates to final candidate data in an original domain; and providing the final candidate data to a second stage of a multistage vector quantizer.

### CROSS-REFERENCE TO RELATED APPLICATIONS

This application is a continuation of U.S. Patent Application Ser. No. 63/454,166, filed Mar. 23, 2023, which claims the benefit of U.S. Provisional Patent Application No. 63/448,440, filed Feb. 27, 2023, the contents of which are incorporated by reference herein in their entireties.

### TECHNICAL FIELD

The present disclosure relates generally to encoding and decoding, and more particularly to multi-stage vector quantization methods and related encoders and/or decoders supporting multi-stage vector quantization.

### BACKGROUND

Vector quantization (VQ) has been widely used in the development of data compression technologies. Notably, VQ is an efficient data compression technique, which constructs a plurality of scalar data columns into a vector and performs overall quantization in the vector space. As a result, the data is compressed while not much information is lost.

A generic 37 bit dimension of 24 coefficients/vector trained stochastic codebook would require: 2³⁷*24=3*2⁴⁰=3.29*10¹² Words(Word16) of read-only memory (ROM) storage. Designing, searching, and storing such a codebook is not practical in most real-world implementations.

In the 1980s and 1990s, the concepts of Split-VQs and Multistage VQs (MSVQs) were developed to reach more reasonable storage and search complexities, while still maintaining substantial vector quantization gains. Coefficient correlation properties are still properly exploited in the training of these VQs.

An example Split-VQ is the Adaptive Multi-Rate Wideband (AMR-WB) Immitance Spectral Frequency (ISF) VQ described in the 3rd Generation Partnership Project (3GPP) technical standard (TS) 26.190, section “5.2.5 Quantization of the ISP coefficients.” There the total number of coefficients is 16, which are split into 9 coeffs(8 bits) and 7 coeffs(8 bits) in the first stage. Likewise, in the second stage, the VQ are further split into {3,3,3} coefficients with (6,7,7) bits and a higher stage 2 split of {3,4} using (5,5) bits. In total 8+8+6+7+7+5+5=46 bits are used, and the total number of ROM table entries then becomes in Matlab syntax: sum((2.\hat{ }[8 8]).*[9 7])+sum((2.\hat{ }[6 7 7]).*[3 3 3])+sum((2.\hat{ }[5 5]).*[3 4])=5.2 kW (Word16), i.e., a much more realistic Table ROM number.

A less complex alternative to the Trained Stochastic (SplitVQ, MSVQ) codebook are codebooks with a given algebraic or lattice structure that are easier to search, but such codebooks will have suboptimal Voronoi regions and typically only be efficient for certain input vector distribution (e.g., Gaussian, Laplacian, etc.). Moreover, efficient indexing schemes (e.g., to construct the final codebook vector from the bit stream) may become costly, and even further, the lattice structures are typically not very flexible in terms of vector length. Examples of lattice quantizers are D8-lattice, RE8-lattice, and Pyramid VQ (PVQ). Spherical PVQ is also used in Enhanced Voice Services (EVS) and Internet Engineering Task Force (IETF) Opus to encode Gaussian sources.

Another possibility is to transform the input signal to a better domain for efficient and quick quantization. One can, for example, use the signal optimized Karhunen Love Transform (KLT) or the more generic discrete cosine transform (DCT) to obtain energy (i.e., via KLT) or frequency (i.e., via DCT) relations for the input signals.

### SUMMARY

There currently exist certain challenge(s). The current solution for the first stage (and subsequent stages) of an MSVQ typically requires a large storage space. For example, in the case of EVS the Frequency Domain—Comfort Noise Generation (FD-CNG) VQ in the first stage uses 128 levels (7 bits) with 24 coefficients each, resulting in (128×24)=3072 Words (i.e., typically one Word may be a 16-bit Word16 integer or a Word may be a single precision 32-bit float) of ROM storage. In the EVS-FD-CNG-VQ (Enhanced Voice Services-Frequency Domain-Comfort Noise Generation-Vector Quantization) implementation, this corresponds to 6 kilobytes (kB), where each byte is 8 bits.

The whole EVS 37 bit(7+5*6) bits FD-CNG VQ (all stages) is using (128+5×64)*24=10752 Word16 or 20 kBytes. This is twice the ROM size of the 46 bit AMR-WB ISF-VQ.

For EVS FD-CNG-VQ, the unstructured first stage is using approximately 30% of the ROM space of the quantizer, while also using 19% (7 bits/37 bits) of the information space.

The absence of an efficient structure in the first stage makes it difficult to provide low storage space and a low complex search solution.

The current per vector iterative update of Nc (i.e., the number of candidates to keep for the 2^{nd} stage) has a high worst case ‘weighted millions of operations per second’ (WMOPS) complexity, as a living list of the Nc(8 in EVS) is potentially updated for every analyzed codebook vector, i.e., the Nc length candidate list may have to be updated 128 times.

Certain aspects of the disclosure and their embodiments may provide solutions to these or other challenges. A transformed segmented structure with a different truncation length (e.g., corresponding to different detail levels) in each segment is introduced into the first stage codebook.

Each segment with its individual truncation length is efficiently searched with an optimized inner loop keeping and/or maintaining a pair (e.g., list of two) of best candidates for each segment.

The number of segments Ns in the first stage are kept around Ns=Nc/2. Thus, at the end of search approximately Nc=2*Ns candidates will be available as desired.

To further improve the quality of the remaining Nc candidates, the list of Nc candidates is updated by using a stored circular list of nearest first stage vectors. This update is performed based on evaluating the first and second best candidate neighbors (e.g., in terms of mean square error, MSE) versus the worst existing entry in the original Nc-list of candidates.

To further improve storage and retrieve characteristics of the first stage, the actual coefficients of the vectors of the segments are stored in a byte (Word8) quantized domain, with a special scaling (e.g., implemented as a shift factor) for each column of a segment.

According to some embodiments, the disclosed subject matter includes a method performed by an encoder that includes obtaining a discrete cosine transform (DCT) target vector. The method further includes performing a sub-optimal pairwise inner search in each segment of a codebook having a plurality of segments with each segment having truncated vectors different from truncated vectors of other segments of the plurality of segments to determine, from each of the plurality of segments, a pairwise initial candidate set to form a plurality of pairwise initial candidates from the sub-optimal pairwise inner searches. The method includes performing post optimization on the plurality of pairwise initial candidates to replace a plurality of the plurality of pairwise initial candidates using a list of candidate neighbors to thereby form a plurality of final candidates. The method includes reconstructing the plurality of final candidates using an inverse type II discrete cosine transform (DCT-II) to transform the plurality of final candidates to a plurality of reconstructed final candidates in an original domain. The method includes providing the plurality of reconstructed final candidates to a second stage of a multistage vector quantizer.

Certain embodiments may provide one or more of the following technical advantage(s). The introduced codebook structure (e.g., transformed and selectively truncated into Ns segments) allow for fast search using less operations (e.g., WMOPS).

The pairwise candidate retrieval within each codebook segment allows for lower complexity (WMOPS) inner loop of the first stage. By efficient swapping in and out of the new best entry in the pair (e.g., list of two).

The codebook vectors are obtained from memory (e.g., ROM) using a per segment and coefficient column specific scaling (exponents stored as shift-factors). The codebook vector mantissa values (e.g., “segment codebook vector” values) are represented by a signed byte each (Word8), thus additionally enabling fast ROM read access as a pair of bytes (Word16) (e.g., efficient Word8 mantissa retrieval in digital signal processors (DSPs) if the vector coefficient truncation length is even for all segments), and further the segmented stage 1 codebook search allows for parallelization of the first stage (e.g., stage #1) VQ inner loops. The Word8 and shift factor representation of each coefficient means that coefficients are selectively truncated in the dynamic range per column. The truncation for each segment means that each vector is also truncated in detail level. Using the DCT, a truncation corresponds to removing a number of high frequency DCT components. As used herein, the term ‘Word8’ may refer to a signed 8 bit integer in the ITU-T G.191 Basic Operators. Likewise, the term ‘Word16’ may refer to a signed 16 bit integer in the ITU-T G.191 Basic Operators.

According to some other embodiments, a method in a decoder to reconstruct a target vector includes receiving an index that contains a plurality of segments, corresponding shift values, and a global offset value vector. The method includes performing a segment and coefficient wise upshift of the vectors in the plurality of segments using the column shift (e.g., ‘col_shift’) values to form upshifted vectors within each of the plurality of segments. The method includes performing an inverse discrete cosine transform, DCT, Type II transform of the upshifted segments. The method includes scaling an output vector from the DCT Type II transform down to an original unscaled FDCNG domain vector. The method includes adding a global offset value vector back to the unscaled frequency domain-comfort noise generation, FD-CNG, domain vector to form the target vector.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of a system view of a FD-CNG-CQ with low ROM and low WMOPS according to some embodiments;

FIG. 2 is an illustration of an example of an operating environment of an encoder according to some embodiments;

FIG. 3 is a block diagram of an audio encoder according to some embodiments,

FIG. 4 is a block diagram of an audio decoder according to some embodiments;

FIG. 5 is a block diagram of a host according to some embodiments;

FIG. 6 is a block diagram of an exemplary virtualization environment in which some components of an encoder or decoder or an encoder or decoder may be implemented according to some embodiments;

FIG. 7 is a block diagram of a first stage FD-CNG VQ search according to some embodiments;

FIG. 8 is a block diagram of a system view of a FD-CNG-CQ with low ROM and low WMOPS supporting a shorter input target vector according to some embodiments;

FIG. 9 is a block diagram of a first stage FD-CNG VQ search supporting a shorter input target vector according to some embodiments;

FIG. 10 is a diagram illustrating operations of an encoder performing DCT BASIS vector extrapolation to extend a short input target vector according to some embodiments.

FIG. 11 a block diagram illustrating a FD-CNG vector reconstruction for MSVQ first stage according to some embodiments;

FIGS. 12-18 are flow charts illustrating operations of an encoder according to some embodiments; and

FIG. 19 is a flow chart illustrating operations of a decoder according to some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, the current solutions for the first stage (and subsequent stages) of an MS-VQ typically still requires a large storage space. For example, in the case of EVS for the FD-CNG VQ, the first stage uses 128 levels (7 bits) with 24 coefficients each, resulting in (128×24)=3072 Words (Word16) of ROM storage. In the EVS FD-CNG VQ implementation, this corresponds to 6 kBytes, where each Byte is 8 bits. The whole EVS 37-bit (7+5*6) FD-CNG VQ (all stages) is using (128+5×64)*24=10752 Word16 or 20 kBytes. This is double the ROM size of the 46-bit AMR-WB ISF-VQ.

In some embodiments, the system described herein shows how to reduce the storage space and comprises a first stage of a multistage VQ to improve the Table ROM and worst case WMOPS properties of the 3GPP EVS-26.445 FD-CNG VQ spectral envelope quantization.

For example, the EVS FD-CNG VQ is used to quantize the spectral envelope used in silence insertion descriptor (SID) frames into 37 bits. Decoded SID frames may then be used to generate a Time domain background signal.

The first stage (i.e., stage #1) optimization of an MSVQ as described below may, however, also be applied to any audio codec vector parameter using Multi Stage vector quantization. For example, the spectral envelope quantized by the MSVQ may be used for Spectral Noise Shaping (SNS) during active music segments or may be used to quantize and represent the spectral envelope for synthesizing active unvoiced speech segments.

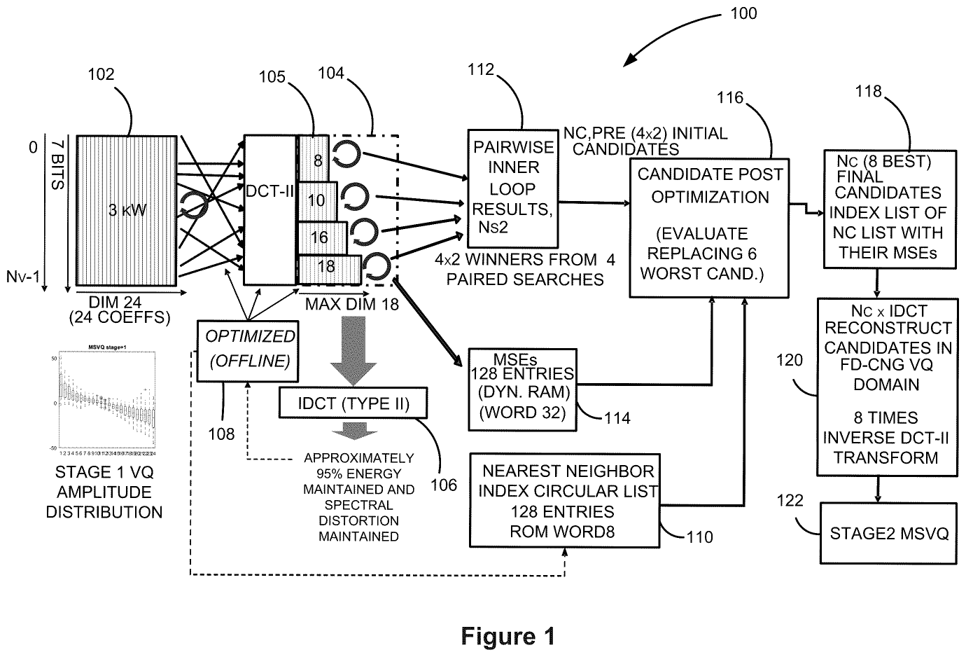

An example enhanced structured Stage 1 search (i.e., first stage search) system 100 is illustrated in FIG. 1. Structural aspects that are conducted a priori off-line and the search and structural aspects that are employed during Nc candidate vector determination are illustrated.

Turning to FIG. 1, the LBG(or Kmeans) trained initial stage 1 VQ codebook 102 has optimal Voronoi regions and, as previously described, uses 128 levels (7 bits) with 24 coefficients each, resulting in (128×24)=3072 Words (Word16) of ROM storage. The codebook 102 enables a full search of 8 candidates (i.e., candidate vectors that can be indicated by and/or pointed to by a codebook index). According to the various embodiments, the codebook 102 is DCT24 transformed into a DCT24 truncated (8, 10, 16, 18) table Word8 codebook 104 (see, e.g., codebook 104 with truncated segment 105 including vectors of length 8 coefficients) with a number of segments, Ns, being 4 segments with a maximum number of 18 coefficients and enables a full search of up to 8 candidates. As indicated below in Table 1, truncated segment 105 contains 16 vectors (e.g., see nSeg[0]==16), each of which has a length of 8 coefficients for a total of 128 values.

The codebook 104 is created off-line and results in 987 Words (Word 16) of ROM storage, roughly 30% of the size of codebook 102. In some embodiments, the codebook 104 has 4 segments (i.e., number of segments, Ns=4). The optimization (e.g., as shown in block 108 in FIG. 1) of the codebook 104 is also performed offline to create the vectors in the codebook 104. This can include performing an inverse DCT (IDCT) transformation of the vectors in codebook 104 to optimize the vectors in the codebook 104 as illustrated by IDCT block 106 and optimization block 108. Notably, the spectral distortion (SD) can be maintained in the creation of codebook 104. The optimization also includes creating a ‘nearest neighbor’ index circular list 110 that contains vectors pointing to a next index or a previous index in an approximate mean square error (MSE) neighbor order. In some embodiments, the nearest neighbor index circular list 110 has 128 entries in ROM Word 8.

Blocks 112-120 as shown in FIG. 1 are part of the FD-CNG VQ search according to various embodiments that feed and/or provide the 8 best candidates to the second stage (e.g., stage 2) of the multistage VQ, as illustrated by block 122, where further processing of the VQ is performed. Prior to describing these blocks, the parameters used shall first be defined in terms of the parameter name, dimension, value(s), and a brief definition, which are indicated below in Table 1.

TABLE 1

| Parameter | Dimension | Value(s) | Definition |
|---|---|---|---|
| Ns | 1 | 4 | Number of segments in the |
| | | | total stage 1 codebook |
| Nc | 1 | 8 | Number of candidates |
| | | | required by stage 2 of the |
| | | | MSVQ |
| Nv | 1 | 128 | Number of vectors in the |
| | | | total stage 1 codebook |
| L | 1 | 7 | L = log2(Nv), bits required to |
| | | | represent the stage 1 |
| | | | codebook indices |
| NMAX_FDCNG | 1 | 24 | Maximum allowed FD-CNG |
| | | | vector length |
| N_WB | 1 | 21 | Example lower FD_CNG |
| | | | vector length |
| N_target | 1 | 24, may be lower than | Current FD-CNG vector |
| | | NMAX_FDCNG | length. |
| | | | Note length 24 is used in |
| | | | EVS 26.445 for SWB and FB |
| | | | input |
| truncLen[s] | Ns | {8, 10, 16, 18} | The DCT truncation length |
| | | | for each stage 1 CB segment |
| nSeg[s] | Ns | {16, 17, 17, 78} | The number of truncated |
| | | | vectors in each stage 1 CB |
| | | | segment |
| nSegCum[s] | Ns + 1 | {0, 16, 33, 50, 128} | Cumulative number of |
| | | | vectors preceding segment s |
| neighb_mse_fwd | Nv | See code tables | vector pointing to a next |
| | | | index in an approximate |
| | | | MSE neighbor order |
| neighb_mse_rev | Nv | See code tables | vector pointing to a previous |
| | | | index in an approximate |
| | | | MSE neighbor order. |
| mse_order_circ | Nv | See code tables | Circular list of indices in an |
| | | | approximate MSE orders |
| col_shift[s][c] | Ns * | See example code tables | Integer exponent (binary |
| | truncLen | | shift factor) of the |
| | | | coefficients column c in |
| | | | segment s |
| target[c] | N_target | Input signal dependent | target FD_CNG vector to be |
| | | | quantized |
| midQ[i], | 24 | See example code tables | Global Mid(mean)-level of |
| | | | the total stage 1 |
| | | | codebook(CB), for each |
| | | | FDCNG coefficient column. |
| | | | Fixed values computed |
| | | | offline |
| cb_segmW8[s][idx][c] | Ns* | See attached example | Word8 mantissa values for |
| | truncLen | code tables | CB segment s, local FDCNG |
| | | | vector index idx, and |
| | | | FDCNG vector column c |
| | | | Total 1974 Word8 values |
| dct_scaleF[i] | 2 | {0.421966, 0.421966²/ | Dynamics optimization |
| | | 2⁸} | scalefactors for the Word8 |
| | | | storage in a binary upshifted |
| | | | DCT domain |
| dct_inv_ScaleF[i] | 2 | {2.369873046875, | Dynamics optimization |
| | | 2.369873046875*16}; | scalefactors for the Word8 |
| | | | storage a binary upshifted |
| | | | DCT domain, (upshift by |
| | | | four bits) |
| target[i] | N_target | Input dependent | The target typically |
| | | | represents a normalized noise |
| | | | envelope vector. |
| target_wb | N_WB | Input dependent | A shorter target typically |
| | | | represents a normalized noise |
| | | | envelope vector for a lower |
| | | | bandwidth. |
| st1_mses[i] | Nv | Input dependent | Global dynamic RAM |
| | | | storage of MSEs for all |
| | | | segments, for post analysis. |
| st1_mse_pair[segm][2] | Ns, 2 | | Initially mse's from the |
| | | | segment pairwise search, |
| | | | later in-place updated (using |
| | | | pointer to vector dist) to be |
| | | | the MSE's for the best set of |
| | | | vector candidates to keep for |
| | | | MSVQ stage #2 |
| st1_idx_pair[segm][2] | Ns, 2 | | Initially idxs's from the |
| | | | segment pairwise search, |
| | | | later in-place updated (using |
| | | | pointer to vector indices)to |
| | | | be indices for the best set of |
| | | | vector candidates to keep for |
| | | | MSVQ stage #2 |
| p_max | 1 | | Pointer to the worst mse |
| | | | (maximum MSE) in a pair |
| | | | (or in a candidate set) |
| p_min | 1 | | Pointer to the best mse (10) |
| | | | minimum MSE) in a pair |
| | | | (or in a candidate set) |
| res[ ] | N_target | | Remaining error signal |
| | | | required for stage #2 |

One feature shared by various embodiments of the disclosed subject matter is the performance savings when comparing the original Table ROM space of 3072 single precision float (32-bits per coefficient) yielding a total ROM storage of 12288 bytes in the EVS floating point specification to the first stage of the FD-CNG VQ, which the first stage uses 128 levels (7 bits) with 24 coefficients each. These performance savings are indicated in Table 2. It should be noted that the Table ROM space in the corresponding EVS fixed point specification is 3072 16-bit integers (Word16's), resulting in a total 6144 bytes of ROM storage.

TABLE 2

| | | Avg. | Delta | | | | | | |
|---|---|---|---|---|---|---|---|---|---|
| | | SD dB | Avg. SD | Spectral Distortion, | | | | SD Worst | |
| | | (low is | increase | (SD) outliers -small | | | | case | |
| Tag | Description | good) | in dB | percentage is good | | | | observation | Note(s) |
| SD_F37b_otab_NB = | LBG-trained | 1.035 | n/a | (>1 dB: | (>2 dB: | (>3 dB: | (>4 dB: | (SD-wc: 3.309 | Optimization |
| 8 + 0 | based codebook | dB | | 51.63%) | 4.25%) | 0.40%) | 0.00%) | frame = | Starting point |
| | with full search | | | | | | | 105333 m: | |
| | of 8 candidates | | | | | | | 30.66 s) | |
| | ROM 3072 | | | | | | | | |
| | float (single | | | | | | | | |
| | precision | | | | | | | | |
| | 32 bit/coeff.) | | | | | | | | |
| | 12288 bytes in | | | | | | | | |
| | EVS-C-float) | | | | | | | | |
| | (The EVS-fixed | | | | | | | | |
| | point Word16 | | | | | | | | |
| | representation | | | | | | | | |
| | requires 6144 | | | | | | | | |
| | bytes of ROM) | | | | | | | | |
| SD_F37b_ntab_NB = | DCT24 | 1.125 | 0.090 | (>1 dB: | (>2 dB: | (>3 dB: | (>4 dB: | (SD-wc: 3.327 | DCT |
| 8 + 0 | truncated | dB | dB | 57.92%) | 4.65%) | 0.36%) | 0.00%) | frame = | truncation |
| | (8, 10, 16, 18) | | | | | | | 105333 m: | and coeff |
| | table Word8 | | | | | | | 30.66 s) | Dynamics |
| | codebook with | | | | | | | | reduction |
| | full search of 8 | | | | | | | | limits max |
| | candidates ROM | | | | | | | | quality |
| | 987 Word16 | | | | | | | | in SD |
| | 1974 bytes. | | | | | | | | somewhat. |
| | (approximately | | | | | | | | |
| | ⅓ compared to | | | | | | | | |
| | EVS fixed point) | | | | | | | | |
| | Benchmark, to | | | | | | | | |
| | reach for a new | | | | | | | | |
| | search for the | | | | | | | | |
| | new | | | | | | | | |
| | representation | | | | | | | | |
| SD_F37b_ntab_NB = | DCT24 + | 1.130 | 0.095 | (>1 dB: | (>2 dB: | (>3 dB: | (>4 dB: | (SD-wc: 3.327 | Optimized |
| DCT2x4 + 0 − 58 | truncation (8, 10, | dB | dB | 58.21%) | 4.71%) | 0.36%) | 0.00%) | frame = | pairwise |
| | 16, 18)) with | | | | | | | 105333 m: | search |
| | pairwise search | | | | | | | 30.66 s) | without |
| | for candidates | | | | | | | | neighbor |
| | | | | | | | | | checking |
| | | | | | | | | | yields |
| | | | | | | | | | slightly |
| | | | | | | | | | worse SD |
| | | | | | | | | | perf. |
| SD_F37b_ntab_NB = | + evaluating 8 | 1.127 | 0.092 | (>1 dB: | (>2 dB: | (>3 dB: | (>4 dB: | (SD-wc: 3.327 | Optimized |
| DCT2x4 + r8 “v5” | final | dB | dB | 57.98%) | 4.71%) | 0.36%) | 0.00%) | frame = | pairwise |
| | optimization | | | | | | | 105333 m: | search with |
| | circular | | | | | | | 30.66 s) | additional |
| | mse_neighbor | | | | | | | | checking of |
| | replacements | | | | | | | | 8 candidates |
| | Cost ~0.01 | | | | | | | | from circular |
| | WMOPS ROM | | | | | | | | MSE nearest |
| | 2x128 bytes | | | | | | | | neighbor list. |
| SD_F37b_ntab_NB = | Two best kept | 1.126 | 0.091 | (>1 dB: | (>2 dB: | (>3 dB: | (>4 dB: | (SD-wc: 3.327 | Optimized |
| DCT2x4 + r6of 128 − | from pair | dB | dB | 57.94%) | 4.74%) | 0.36%) | 0.00%) | frame = | pairwise |
| | search, + 128x6 | | | | | | | 105333 m: | search, |
| | total full | | | | | | | 30.66 s) | followed by |
| | | | | | | | | | a too costly |
| | re-optimization | | | | | | | | full post re- |
| | Cost +0.1 | | | | | | | | optimization |
| | WMOPS | | | | | | | | of 6 |
| | High WMOPS | | | | | | | | candidates |
| | reference | | | | | | | | |

In some embodiments, the first stage codebook 104 has been structured so that it contains segments (e.g., 4) with different DCT truncation lengths (e.g., 8, 10, 16, 18). Each segment has a fixed common truncation length (e.g., number of remaining coefficients) for its set of vectors. For example, in the context of the present disclosure, a length of 24 coefficients would be indicative of no truncation of the length of the vector(s), while a truncation length of 8 coefficients would be indicative that a vector(s) has been truncated and/or reduced to a length of 8 coefficients. The resulting dimensionality reduction reduces both storage size and search complexity.

In the present disclosure, a design with Ns=4 segments with different truncation lengths will be used. Each segment has different frequency characteristics including ranging from a low frequency codebook to mid-frequency codebook(s) to high frequency codebook(s).

In some embodiments, the truncation lengths have been optimized off-line. One example straightforward design method for establishing the truncation length is to simply set a relative energy requirement as follows:

In a first step, train a nontruncated stochastic base codebook with vector lengths of N_FDCNG using the kmeans or LBG VQ-training algorithms.

For each vector included in the base codebook 102, an initial individual truncation length is set to the length where there is a significant majority, e.g., 95%, of the vector energy left.

In a second step, the initial vector lengths are individually increased so that Ns subsets with equal truncation lengths can be created. Each of these subsets may then be denoted as a segment with equal truncation length, and all subsets have at least 95% energy remaining.

In some embodiments, an additional criteria can be added such that the reconstruction point of each vector in the set of truncated codebook vectors should not move into another vector's index Voronoi region in the original kmeans/LBG trained base codebook (CB). And in further embodiments, the allowed movement away from the original reconstruction point can be limited so as to not stray too far away from the original base codebook's Voronoi-region setup.

Prior to describing the first stage FD-CNG VQ search and reconstruction, an overview of an operating environment, an encoder, a decoder, a host, and a virtualization environment shall first be described herein.

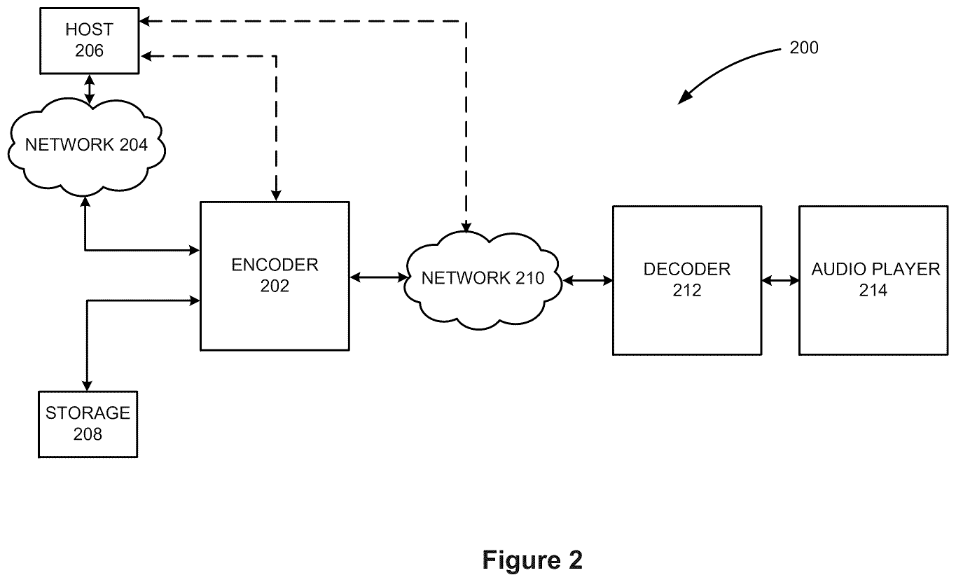

FIG. 2 illustrates an block diagram of an example operating environment 200 in which the various embodiments of the present disclosure may be implemented. Turning to FIG. 2, in the example operating environment 200, the encoder 202 receives data, such as an audio file, to be encoded from an entity through network 204, such as a host 206, and/or from storage 208. The encoder 202 in various embodiments is a parametric stereo encoder. In some embodiments, the host 206 may communicate directly to the encoder 202. In some embodiments, the encoder 202 may encode the audio file as described herein and either stores the encoded audio file in storage 208 or transmits the encoded audio file to a decoder 212 via network 210. The decoder 212 in various embodiments is a parametric stereo decoder. The decoder 212 decodes the audio file and transmits the decoded audio file to an audio player 214 for playback. The audio player 214 may be or be comprised in a user equipment, a terminal, a mobile phone, and the like. In other embodiments, the host 206 may transmit encoded audio files to the decoder 212 via network 210.

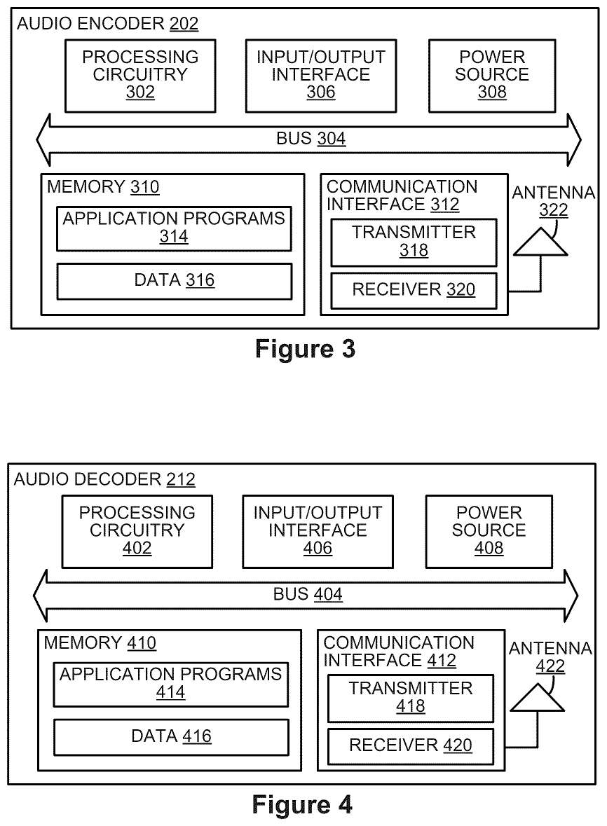

FIG. 3 shows an audio encoder 202 in accordance with some embodiments where the audio encoder 202 is implemented as a stand-alone device. As used herein, an audio encoder refers to a device capable, configured, arranged and/or operable to encode objects and communicate with network nodes, encoders, and/or decoders. Examples of an audio encoder include, but are not limited to, a smart phone, mobile phone, cell phone, voice over IP (VoIP) phone, wireless local loop phone, desktop computer, personal digital assistant (PDA), wireless cameras, gaming console or device, storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

An audio encoder may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, an encoder may not necessarily have a user in the sense of a human user who owns and/or operates the relevant device.

The audio encoder 202 includes processing circuitry 302 that is operatively coupled via a bus 304 to an input/output interface 306, a power source 308, a memory 310, a communication interface 312, and/or any other component, or any combination thereof. Certain decoders may utilize all or a subset of the components shown in FIG. 3. The level of integration between the components may vary from one decoder to another decoder. Further, certain decoders may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 302 may include multiple central processing units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into the audio encoder 202. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the audio encoder 202 via input circuitry or an interface such as an electrical power cable. Delivering power may be, for example, for charging of the power source 308. Power circuitry may perform any formatting, converting, or other modification to the power from the power source 308 to make the power suitable for the respective components of the audio encoder 202 to which power is supplied.

The memory 310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the audio encoder 202, any of a variety of various operating systems or combinations of operating systems.

The memory 310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 310 may allow the audio encoder 202 to access instructions, application programs and the like, stored on transitory or non-transitory memory media, to off-load data, or to upload data. An article of manufacture, such as one utilizing a communication system may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., a UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., antenna 322) and may share circuit components, software or firmware, or alternatively be implemented separately.

In the illustrated embodiment, communication functions of the communication interface 312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, an audio encoder may provide an output of encoded data, through its communication interface 312, via a wireless connection to a network node.

An audio encoder when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a thermostat, an electrical door lock, a connected doorbell, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement. A decoder in the form of an IoT device comprises circuitry and/or software in dependence of the intended application of the IoT device in addition to other components as described in relation to the audio encoder 202 shown in FIG. 3.

FIG. 4 illustrates an audio decoder 212 (e.g., a parametric stereo encoder) in accordance with some embodiments where the audio decoder 212 is implemented as a stand-alone device. As used herein, an audio decoder refers to a device capable, configured, arranged and/or operable to decode objects and communicate with network nodes, encoders, and/or decoders. Examples of an audio decoder include, but are not limited to, a smart phone, mobile phone, cell phone, voice over IP (VoIP) phone, wireless local loop phone, desktop computer, personal digital assistant (PDA), wireless cameras, gaming console or device, storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

An audio decoder may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a decoder may not necessarily have a user in the sense of a human user who owns and/or operates the relevant device.

The audio decoder 212 includes processing circuitry 402 that is operatively coupled via a bus 404 to an input/output interface 406, a power source 408, a memory 410, a communication interface 412, and/or any other component, or any combination thereof. Certain decoders may utilize all or a subset of the components shown in FIG. 4. The level of integration between the components may vary from one decoder to another decoder. Further, certain decoders may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the audio decoder 212. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the audio decoder 212 via input circuitry or an interface such as an electrical power cable. Delivering power may be, for example, for charging of the power source 408. Power circuitry may perform any formatting, converting, or other modification to the power from the power source 408 to make the power suitable for the respective components of the audio decoder 212 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the audio decoder 212, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 310 may allow the audio decoder 212 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., a UE or a network node in an access network). Each transceiver may include a transmitter 318 and/or a receiver 320 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, an audio decoder may provide an output of decoded data, through its communication interface 412, via a wireless connection to a network node.

An audio decoder when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a thermostat, an electrical door lock, a connected doorbell, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement. A decoder in the form of an IoT device comprises circuitry and/or software in dependence of the intended application of the IoT device in addition to other components as described in relation to the audio decoder 212 shown in FIG. 4.

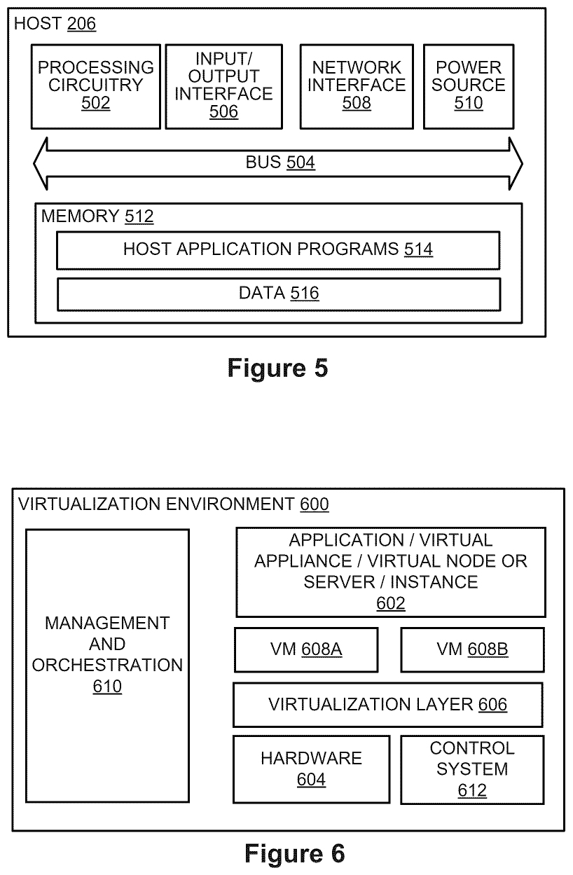

FIG. 5 is a block diagram of a host 206 in accordance with various aspects described herein. As used herein, the host 206 may be or comprise various combinations hardware and/or software, including a standalone server, a blade server, a cloud-implemented server, a distributed server, a virtual machine, container, or processing resources in a server farm. The host 206 may provide one or more services to one or more UEs.

The host 206 includes processing circuitry 502 that is operatively coupled via a bus 504 to an input/output interface 506, a network interface 508, a power source 510, and a memory 512. Other components may be included in other embodiments. Features of these components may be substantially similar to those described with respect to the devices of previous figures, such as FIGS. 3 and 4, such that the descriptions thereof are generally applicable to the corresponding components of host 206.

The memory 512 may include one or more computer programs including one or more host application programs 514 and data 516, which may include user data, e.g., data generated by a encoder or decoder for the host 206 or data generated by the host 206 for a UE. Embodiments of the host 206 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., FLAC, Advanced Audio Coding (AAC), MPEG, G.711, EVS, Immersive Voice and Audio Services (IVAS)), including transcoding for multiple different classes, types, or implementations of UEs (e.g., handsets, desktop computers, wearable display systems, heads-up display systems). The host application programs 514 may also provide for user authentication and licensing checks and may periodically report health, routes, and content availability to a central node, such as a device in or on the edge of a core network. Accordingly, the host 206 may select and/or indicate a different host for over-the-top services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 6 is a block diagram illustrating a virtualization environment 600 in which functions implemented by some embodiments of the audio encoder 202 or components of the audio encoder 202 or by some embodiments of the audio decoder 212 or components of the audio decoder 212 may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a decoder, encoder, network node, UE, core network node, or host. Further, in embodiments in which the virtual node does not require radio connectivity (e.g., a core network node or host), then the node may be entirely virtualized.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 600 (also referred to as hypervisors or virtual machine monitors (VMMs)), provide VMs 608A and 608B (one or more of which may be generally referred to as VMs 608), and/or perform any of the functions, features and/or benefits described in relation with some embodiments described herein. The virtualization layer 600 may present a virtual operating platform that appears like networking hardware to the VMs 608.

The VMs 608 comprise virtual processing, virtual memory, virtual networking or interface and virtual storage, and may be run by a corresponding virtualization layer 600. Different embodiments of the instance of a virtual appliance 602 may be implemented on one or more of VMs 608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 608 may be a software implementation of a physical machine that runs programs as if they were executing on a physical, non-virtualized machine. Each of the VMs 608, and that part of hardware 604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 608 on top of the hardware 604 and corresponds to the application 602.

Hardware 604 may be implemented in a standalone network node with generic or specific components. Hardware 604 may implement some functions via virtualization. Alternatively, hardware 604 may be part of a larger cluster of hardware (e.g., such as in a data center or CPE) where many hardware nodes work together and are managed via management and orchestration 610, which, among others, oversees lifecycle management of applications 602. In some embodiments, hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 612 which may alternatively be used for communication between hardware nodes and radio units.

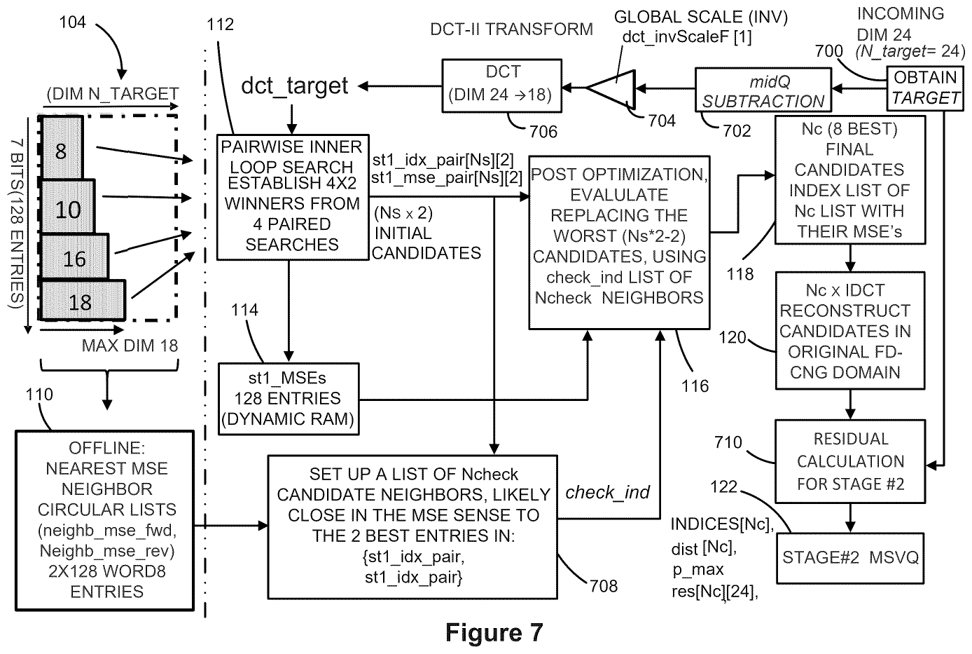

Turning now to FIG. 7, the first stage (e.g., stage #1) FD-CNG VQ search using the codebook 104 (e.g., as indicated above and shown in FIG. 1) created offline shall now be described.

In some embodiments, the encoder 202 (i.e., as depicted in FIG. 2) obtains a target vector in block 700. For example, the input target vector of length N_target may be obtained using the 3GPP EVS-codec analysis algorithm, as outlined in reference 3GPP TS 26.445 encoder.

In some instances, the FD-CNG noise estimator relies on a hybrid spectral analysis approach. Low frequencies corresponding to the core bandwidth are covered by a high-resolution Fast Fourier Transform (FFT) analysis, whereas the remaining higher frequencies are captured by the CLDFB which exhibits a significantly lower spectral resolution of 400 Hz.

The input signal to the EVS audio/speech encoder may be configured to quantize the spectrum in the FD_CNG domain, such that the EVS algorithm may quantize the FDCNG target vector of dimensions 17, 20, 21 and 24. The present disclosure describes the case when N_target is 24, however the first stage MSVQ method may also apply to the other dimensions. In alternate embodiments, N_target can be 21 (e.g., 21(N_WB)) without departing from the scope of the disclosed subject matter. However, when using the same stored codebook (e.g., a set of DCT-II trained codebooks trained on dimension 24) for other smaller dimensions (e.g., 17, 20, 21), special care should be taken to generate a nearly distortion free target vector of dimension 24 (e.g., the same DCT dimension used in codebook training).

Exemplary operations may include a first operation that comprises a non-normalized target signal in the EVS-description being denoted as N_{FD-CNG}(i) (wherein ‘N’ stands for Noise) Moreover, in the EVS specification, the encoding of N_{FD-CNG}(i) is provided in “5.6.3.5 Encoding SID frames in FD-CNG.” Notably, the length L_{SID} in EVS corresponds to the variable N_target as disclosed herein. The final determination of the N_{FD-CNG} variable in EVS can be found in section “5.6.3.3 Adjusting the first SID frame in FD-CNG” (Eq. 1395), for a first SID-frame after a speech frame.

A second operation includes both a log domain conversion and a spectral envelope normalization. In the EVS specification, the N_{FD-CNG}(i) signal is converted to the log 10 dB domain in “Section 5.6.3.5” Equation (1396). The normalized signal

$${\overline{N}}_{F D - C N G}^{dB} ( i )$$

is then obtained in Equation (1397). In this description, the target signal target[i] of length N_target, corresponds to the EVS specification signal

$${\overline{N}}_{F D - C N G}^{dB} ( i )$$

of length L_{SID}.

In some embodiments, the encoder 202 in operation 702 removes a global offset value vector, indicated herein as a midvalue vector. In other embodiments, the offset value vector may be a mean value vector, a median value vector, or the like. This is done to reduce the dynamics of the signal both in quantization and in storage. The target signal obtained is subtracted by an off-line analyzed global offset value vector in the FD-CNG domain. An example of such an operation may be mathematically described as:

$$target\_mr [ i ] = target [ i ] - midQ [ i ] , for i ∈ 0 … ( N\_target - 1 ) .$$

In some embodiments, the encoder in operation 704 may utilize a DCT and IDCT related operation to add a global scale factor to scale the target vector up to the dynamics and/or range maximized search domain. More specifically, to maximize storage and search precision within a Word8 mantissa, a global scale factor is applied to the mid removed target vector. An example of such an operation may be mathematically described as:

$$target\_mr \_scaled [ i ] = target\_mr [ i ] * dct\_invScaleF [ 1 ] ,$$

$$for i ∈ 0 … ( N\_target - 1 )$$

where dct_invScaleF[1] maximizes the storage dynamics and further scales up the target vector to the search domain including 4 binomials or bits (i.e., 4 “decimals” in the binary domain). The objective of this DCT implementation related operation is to scale up the mid-removed signal to a target level before applying the DCT to improve the search precision (e.g., granularity). Without this upscaling, the dct_target vector (after DCT processing) will exhibit a low dynamics range. In a floating point implementation the lack of upscaling is largely inconsequential, but in a fixed point implementation (i.e., with limited precision) it is important to maximize the DCT-input signal dynamics range and the DCT-output signal range. Otherwise, the DCT transformation will likely add analysis noise without the upscaling.

In some embodiments, the scaled target vector signal is transformed by the encoder 202 to the DCT24 search domain in operation 706. The transformation results in the DCT target vector, which is indicated herein as ‘dct_target’. The DCT type II transform (e.g., operation 706 in FIG. 7) may be applied as follows:

$$dct\_target = dct ( target\_mr \_scaled )$$

where target_mr_scaled always has the dimension 24 (NMAX_FDCNG). Even if N_target is lower than NMAX_FDCNG, the analysis DCT is executed using dimension NMAX_FDCNG. This avoids implementing several different DCTs (and IDCTs), and the mantissa and scale factor can be optimized for one DCT length.

In some embodiments, the encoder 202 calculates the common MSE contribution for the globally truncated DCT coefficients. The potential common truncation in the DCT search domain for the DCTs truncation lengths in all segments in a segmented first stage codebook yields a common high coefficient error contribution. This error needs to be computed in case one additional first stage segment does not employ a transformation to provide proper comparison of the first stage mean squared error. An example of such an operation may comprise optionally synthesizing the truncated target and compute the common error, i.e., set and/or truncate the DCT target (e.g., dct_target) vector components from max(Nseg)==18 to N_target−1=23 to zero.

In operation 112, the encoder 202 performs a pairwise inner loop search to establish 8 (i.e., 4×2) “winners” from 4 paired searches. The pairwise search is a globally sub-optimal pair-wise search of the four different codebooks of codebook 104 followed by post optimization in operation 116.

To perform the search, the encoder 202 may establish a segment loop setup. The operations and/or steps described below are conducted for segm=0 up to and including segm=Ns−1, in that specific order. For example, in a first example step, tLen is set to truncLen[segm] for the duration of segment segm. Further, st1_mse_pair[segm][0] is set to a very large value (MAX_FLOAT) and st1_mse_pair[segm][1] is set to a very large value (MAX_FLOAT). This initialization ensures that both values will be updated. Moreover, p_max, pointing to the worst vector in a segment pair, is initialized to 0.

As part of the disclosed operations/steps, the encoder may calculate the common MSE contribution for the segment's truncated coefficients. A truncation error up to truncLen[Ns−1] per segment is needed to be able to eventually compare the MSE errors between the different segments. For example, a first operation may include initializing the MSE variable by setting mse_trunc_segm[segm]=mse_trunc_all_segms. Further, the error energy of this segment's truncated target coefficients can be summed up to the global maximum truncation length truncLen[Ns−1]>=tLen. In addition, mse_trunc_segm[segm]+=(dct_target[tLen+i])², for i∈0 . . . (truncLen[Ns−1]−tLen−1).

As part of the disclosed operations/steps, the encoder 202 points to the current segment's codebook and scale factors. An example first operation and/or step includes pointing to the current segment cb, the common codebook for this segment where all vectors have a truncation length truncLen[segm], where cb=cb_segmW8[segm]. In a subsequent step/operation, the current segment col_shift vector is pointed to, wherein the coefficient columns scaling codebook for this segment segm, where all col_shift vectors have the length tLen, which may be mathematically represented as dct_col_shift_tab=col_shift[segm]. As used herein, the terms ‘column shift’ or ‘col_shift’ may represent an integer that indicates an exponent value for a scaling factor, e.g., a scaling factor equal to 2^{[col_shift]}.

As part of the disclosed operations/steps, the encoder 202 performs a per vector setup within each segment segm. The steps in summing up the MSE for the non-truncated coefficients are completed for idx=0 and up to and including idx=nSeg[segm−1], in that specific order. For example, a first example operation may include computing the idx_full to be able to store this CB vector's MSE in a structured manner, for each of the Nc candidates' post optimization step. Notably, idx_full=idx+nSegCum[segm]. Afterwards, the local mse is initialized with the common contribution for this segment, i.e., mse_{idx}=mse_trunc_segm[segm]. Afterwards, the MSE is calculated for the current codebook vector idx, using tmp[c]=dct_target[c]−cb[idx][c]*^{2col_shift_tab[c]}, for c∈0 . . . (tLen−1), and setting mse_{idx}+=tmp[C]², for c∈0 . . . (tLen−1). Notably, this is the inner MSE calculation loop where DCT truncation pays off, in terms of reducing WMOPS complexity, as only coefficients ranging from 0 to tLen−1 are now affecting the MSE summation.

In some embodiments, the encoder 202 subsequently saves the MSE value for the current vector index. This step is optional in some embodiments and serves as an “extended candidate” analysis or post analysis step for selecting the final candidate vectors from stage 1. For example, the MSE value may be set via st1_mses[idx_full]=mse_{idx}. As previously indicated, these stored MSE values may be used in a subsequent low complex post analysis step.

In some embodiments, the encoder 202 then conditionally updates the pair of best values for this segment. For example, a first example operation and/or step includes first evaluating if the current vector is better than the worst in the segment pair (i.e., if the current vector has a lower MSE than the highest MSE among the segment vector pairs that have been evaluated so far). As used herein, a vector is ‘better’ if it has a lower MSE, whereas a vector is “worst” if it has the highest MSE. Notably, one can start with a conditional update of the worst index, which is pointed to by p_max,

if ( mse_{idx} < st1_mse_pair[segm][p_max] ) {
st1_idx_pair[segm][p_max] = idx_full;
}

In a second operation, the best MSEs may be conditionally updated via

if ( st1_idxpair[segm][p_max] == idx_full ) {
st1_mse_pair[segm][p_max] = mse_{_{—}}_{idx} ;
}
/* two ops L_sub( ) , move16( ) */

In a third operation, p_max is updated after each new candidate. Always reevaluate if there are a new worst candidates stored.

p_max = 0;
if ( st1_mse_pair[0] < st1_mse_pair[1] )
{
p_max = 1; /* 0 is better */ /* move16( ) */
}

Here, the legacy MSVQ stage #1 solution keeps a complex bookkeeping record of a list of e.g., 8 (or even 24) values, potentially causing large worst case (WC) complexity issues.

At this stage, all Ns segments have been processed by the encoder 202.

Notably, there are Ns*2 stored preliminary candidates in the variables:

st1_mse_pair[Ns][2] (best mse values from segment wise search)
st1_idx_pair[Ns][2] (best idx_full values from segment wise search)

wherein the Nv (128) stored MSE values in st1_mse have been created.

In this example with Ns=4, the required Nc=8 stage #2 candidate values have already been determined. Among these Nc values, it is known from the serial pairwise search that at least two of the values correspond to a global minima among all 8 values. However, the Nc−2 (i.e., in this case 6) value may represent suboptimal candidates for stage #2 of the multistage VQ.

As the DCT-type II truncated segments have different truncation lengths, these segments will have differences in high frequency components content. In other words, the different codebook segments can be considered to have different low-pass filters applied.

Typically, these Ns*2 Nc candidates may be acceptable for the second stage search. However, in the case of an input target signal that has more than a pair of good vectors within a segment, it is beneficial to check if some of the candidates (e.g., final pairwise search candidate vectors) can be replaced by better candidates.

As a preparation for the second stage the st1_mse_pair matrix is serialized into a MSE vector dist of length Ns*2 and also the candidate index vector st1_idx_pair matrix is serialized in the same way, into a vector indices of length Ns*2.

(Note: this in-place serialization is a no cost operation in C)

In some embodiments, pointer p_max is updated to point to the worst candidate in dist and indices, by searching of the maximum MSE value in dist.

For example, a first operation may include pointer p_max being updated to point to the worst candidate in vector dist and indices, by searching of the maximum in dist p_max=maximum(dist, Nc), where max_index=maximum(vec, len) is a function selecting the maximum index for the values in a vector vec of length len and returning the index of the maximum value in vec as max_index.

Further, the two best candidates (i.e., lowest MSE) are located as follows:

p_min[0] = minimum(dist, Nc);
mse_memory = dist[p_min[0]]; /*remember best MSE value */
dist[p_min[0]]=MAX_FLOAT; /* a very high value*/
p_min[1]= minimum(dist, Nc);
dist[p_min[0]])= mse_memory /*restore*/

where min_index=minimum(vec, len) is a function that selects the minimum index for the values in a vector vec of length len and returning the index of the minimum value in vec as min_index.

In operation 116, the encoder 202 selects the final set of Nc candidates using a circular MSE neighboring index list.

In some embodiments, the circular MSE neighboring index list is performed by the encoder 202 in operation 708. Off-line, the vectors in a global temporary codebook (e.g., in this case the serial concatenation of the vectors in the Ns=4 segment codebooks cb_temporary_full=[cb_segmW8[0], cb_segmW8[1], cb_segmW8[2], cb_segmW8[Ns−1]]) have been analyzed (e.g., analyzed off-line) into an self-MSE ordered vector of indices of length Nv.

In some embodiments, a version of this circularly ordered vector can be obtained by analyzing the MSE between the codebook vectors and applying an approximate Traveling Sales Person(TSP closed) problem solving solution, to the vectors in cb_temporary_full. The distance measure between two cities corresponds to the MSE between two separate vectors in the codebook. Essentially each vector index in the codebook denotes a city for the traveling salesperson problem statement and the MSE between vectors corresponds to the distance between the two cities.

In this example, a Convex-Hull method for the Closed TSP problem is used to obtain an ordering vector mse_order_circ of length Nv across all the segments in the full concatenated codebook cb_temporary_full. To save cycle complexity at the cost of a limited ROM cost, the vector of circularly ordered indices mse_order_circ can be used to create two auxiliary vectors, neighb_mse_fwd and neighb_mse_rev as indicated below in Table 3.

TABLE 3

| Parameter | Length | Description | Note |
|---|---|---|---|
| neighb_{—} | Nv | vector pointing to | i.e., |
| mse_fwd[i] | | a next neighbor | neighb_mse_fwd[idx] |
| | | index in an | points to a rather close |
| | | approximate | neighbor in the MSE |
| | | circular MSE | sense, in the forward |
| | | neighbor order | direction of ordered |
| | | | indices in vector |
| | | | mse_order_circ |
| neighb_{—} | Nv | vector pointing to | i.e., |
| mse_rev[i] | | a previous index | neighb_mse_rev[idx] |
| | | in an approximate | points to a rather close |
| | | circular MSE | neighbor in the MSE |
| | | neighbor order. | sense, in the reverse |
| | | | direction of ordered |
| | | | indices in vector |
| | | | mse_order_circ |

Notably, neighb_mse_fwd and neighb_mse_rev may also be created during runtime using the mse_order_circ vector of indices.

As part of the optimization in operation 116 (e.g., in FIG. 1 or 7), the encoder 202 may perform a first operation and/or step that comprises setting up a vector check_ind of a total of Ncheck=8 promising cross segment candidate indices (full index):

```
/* Use MSE circular neighbors to the two best candidates so far */
  check_ind[0] = neighb_mse_fwd[p_min[0]];
  check_ind[1] = neighb_mse_rev[p_min[0]];
  check_ind[2] = neighb_mse_fwd[p_min[1]];
  check_ind[3] = neighb_mse_rev[p_min[1]];
```

Afterwards, a second operation includes following the circular list one additional step in each direction by:

check_ind[4] = neighb_mse_fwd[check_ind[0]];
check_ind[5] = neighb_mse_rev[check_ind[1]];
check_ind[6] = neighb_mse_fwd[check_ind[2]];
check_ind[7] = neighb_mse_rev[check_ind[3]];

In a third operation, the saved global MSE values are used to check if these are better candidates than the initial Nc candidates from the fast pairwise search. In some instances, only up to Nc−2 candidates are replaced (e.g., in the steps described below).

For example, the two best candidates are first excluded (Note: a global exclusion to never reselect/use two (best) MSE values so far).

```
st1_mses [p_min[0]] = FLT_MAX; /* exclude */
st1_mses [p_min[1]] = FLT_MAX; /* exclude */
for (i = 0; i < Ncheck; i++) {
  /*a scale multiplication to get the inner/outer loop MSE domain correct */
  check_mse = st1_mses[check_ind[i]]*fdcng_dct_scaleF[2];
  IF (check_mse < dist[p_max] ) {
        dist[p_max] = check_mse;
      indices[p_max] = check_ind[i];
      st1_mses[check_ind[i]] = FLT_MAX; /* exclude */
      /* establish a new current worst candidate among all 8 (Nc) */
      p_max = maximum(dist, Nc);
    }
}
```

In a fourth operation, the first stage search part for the second stage candidate indices may exist, while Nc candidate indices are available in indices[ ] and their MSEs are available in dist of length Nc.

As shown in FIG. 7, the result of operation 116 is provided to operation 118 by the encoder 202. The final candidates are transformed by the encoder 202 to the original FD-CNG domain.

In some embodiments, the second stage needs to have the correct error signals (e.g., each of the Nc vectors may have a corresponding error vector signal, res[cand], a.k.a. residual signal, as input to stage 2) in the FDCNG domain, as the upper stage(s) have been scaled and prepared in that specific domain.

For example, the upper FD-CNG stages can be found in the EVS 3GPP specification TS 26.445.

Notably, the best Nc MSEs values do not have to be recalculated for the candidates as the DCT transformation/rotation does not change the MSE distance to the target signal. However, if the input signal length is shorter than the search (and stored codebook) DCT length, the Nc best MSEs may be updated to the proper shorter MSE domain by excluding the error from the upper zeroed or upper extended part. In operation 710, the following steps are performed by the encoder 202. Notably, a first operation and/or step includes, for each of the selected Nc candidates in indices, obtaining the residual vector signal res[cand][ ]

```
for( cand= 0; cand <(Nc); cand++)
{
  idx_full = indices[cand];
  dec_vec[0 ...(N_target-1)] is obtained by decoding vector idx_full,
  res[cand][i] = (target[i] − dec_vec[i] ), for i ∈ 0 .. (N_target-1)
}
```

In a second operation, the stage #2 (i.e., second stage) search may commence, where Nc candidate indices are available in indices[ ], their MSEs are available in dist[ ], and the residual signal in the FDCNG domain is available as res[Nc][N_target]. Further, the worst candidate is indicated by p_max.

The encoder 202 (or decoder 212) receives index idx_full in the range [0 . . . (Nv−1)] and reconstructs the transmitted FDNCG vector fdcng_final_{idx_full} of length N_target as follows.

In a first operation, idx_full is decomposed into segment segm and local idx, i.e., first identify the segment segm, and the local index idx.

```
segm = 0;
for (s = 1; s <= Ns , s++) {
  if ( idx_full >= nSegCum[s] ) {
      segm++;
    }
}
idx = idx_full − nSegCum[segm ];
idx is now the local index in the segment specific codebook cb_segmW8[segm].
```

In a second operation, the algorithm points to the correct exponent table for segment segm by:

expTable = col_shift[segm];
Note: the expTable vector has a length of tLen = truncLen[segm].

In a third operation, the process includes retrieving and scaling the FDCNG vector with DCT domain coefficients corresponding to idx from Table ROM memory

```
for (c = 0; c< tLen ; c++) {
  int coeffWord16 = cb_segmW8[segm][idx][c];
  dct_vec[c] = (float) ( coeffWord16 << expTable[c]);
}
```

Notably, the mantissa values cb_segmW8[segm][idx][c], stored as bytes(Word8), may be retrieved and upscaled using the C-binary left shift operator “<<”. In an all float arithmetic the dct_vec vector is equivalently obtained as:

$$dct\_vec [ c ] = {( cb\_segmW8 [ segm ] [ idx ] [ c ] )}^{*} {2}^{expTable [ c ]} ,$$

$$for c ∈ 0 … ( tLen - 1 )$$

Optionally, in an optional DSP optimized fixed point implementation, the DSP instruction set may not be able to retrieve Word8 efficiently from ROM or RAM. To manage that case, it may be preferable to retrieve the coefficients in consecutive byte pairs (a Word16) as follows:

Retrieve and scale the FDCNG vector with DCT domain coefficients corresponding to idx from Table ROM memory:

```
for (d = 0; d < tLen/2 ; d++) {
  int coeffpairWord16 = cb_segmW8[segm][idx][2*d];
  c = d*2;
  dct_vec[c] = (float) ( AND(coeffPair Word16, 0xFF00) << (expTable[c] − 8));
    dct_vec[c+1] = (float) ( AND(coeffPair Word16, 0x00FF) << expTable[c+1]);
}
```

where AND(a,b) is a bitwise ‘and’ function operating on a 16 bit(Word16) variable. For example, the mantissa values cb_segmW8[segm][idx] are in this DSP optimized version retrieved as 2 byte chunks(Word16's). In some embodiments, each word is masked with a bitwise AND, and properly scaled using the C-binary left shift operator “<<”. This DSP optimization may be applied to both the first stage search in the encoder and to the first stage reconstruction in the decoder.

In a fourth operation, the DCT domain vector is transformed to the mid removed FDCNG domain by setting the dct_vec vector components above tLen to zero, such that

$$dct\_vec [ i ] = 0. ; for i ∈ tLen … ( NMAX\_FDCNG - 1 ) .$$

Further, the IDCT Inverse DCT type II transform is applied as follows:

$$idct\_vec1 = idct ( dct\_vec ) ;$$

$$where dct\_vec has the dimension 24 ( NMAX\_FDCNG ) .$$

Notably, even if N_target is lower than NMAX_FDCNG, the synthesis IDCT is run using dimension NMAX_FDCNG.

In a fifth operation, the vector is scaled down to the original unscaled FDCNG domain (e.g., the Word8 mantissa representation was upscaled using a global value) by:

$$idct\_vec \_global \_scaled [ i ] = idct\_vec1 [ i ] * dct\_scaleF [ 1 ] ,$$

$$for , for i ∈ 0 … ( N\_target - 1 ) .$$

In a sixth operation, the mid stage #1 CB vector is added via:

$${fdcng\_final}_{idx \_ full} [ i ] = idct\_vec \_global \_scaled [ i ] + midQ [ i ] ,$$

$$for i ∈ 0 … ( N\_target - 1 ) .$$

In some embodiments, this reconstruction principle enables a fast search in a residual(offset-removed) truncated DCT-II domain and further enables storage of the CB code vectors with a mantissa of size Word8.

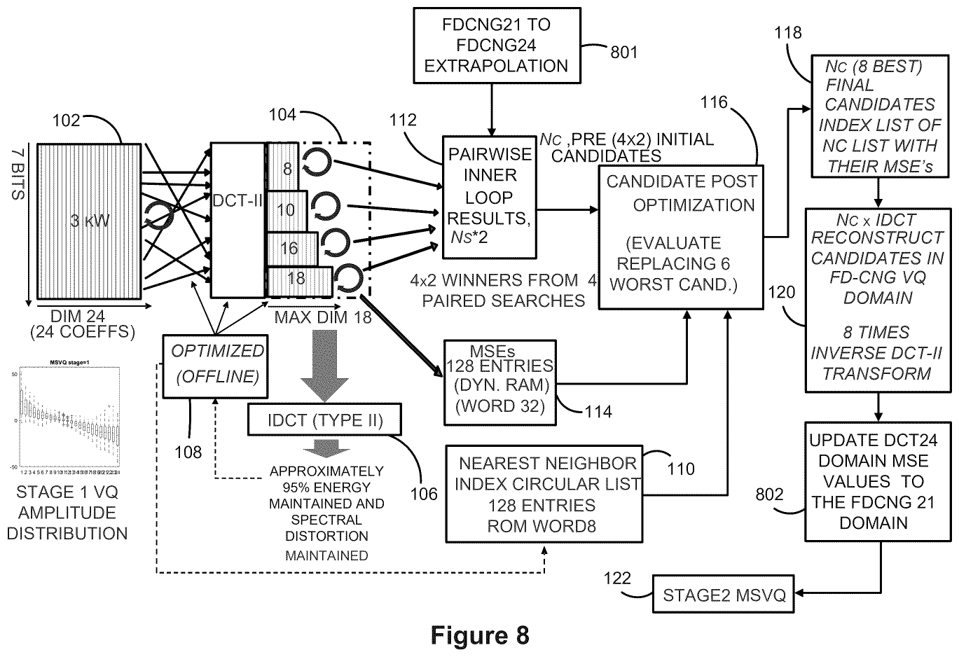

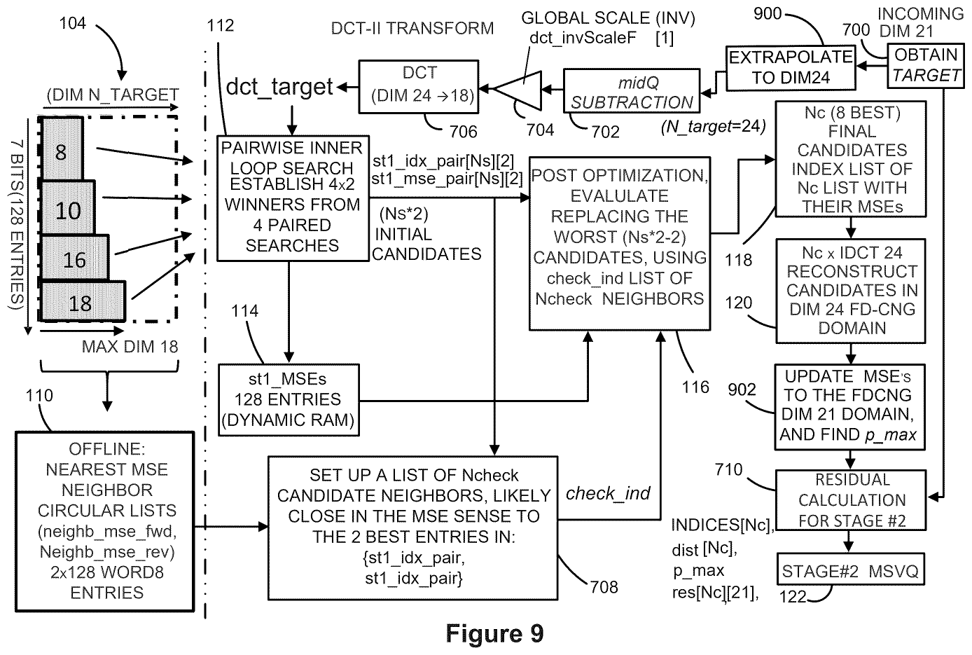

Notably, the codebook 104 created for dimension 24 (NMAX_FDCNG) can be used for vectors of different dimensions. This is illustrated in FIGS. 8 and 9 where the codebook 104 is used to quantize a vector of dimension 21(N_WB). FIG. 8 is a block diagram of a system view of a FD-CNG-VQ with low ROM and low WMOPS supporting a shorter input target vector. FIG. 8 is similar to FIG. 1, but has two additional blocks, which are blocks 800 and 802. Unless otherwise described, the encoder 202 performs the same operations in blocks 102-122 of FIG. 8 as the corresponding blocks in FIG. 1 described above. In block 801, the FDCNG 21 domain values to the target vector are extrapolated to FDCNG 24 domain values. As previously indicated, the output of block 120 has values corresponding to the dimension DCT24 domain. In block 802, the DCT24 domain MSE values are updated to the FDCNG 21 domain.

Referring now to FIG. 9, the first stage (i.e., stage #1) FD-CNG VQ search using the codebook 104 that is created offline for dimension 24 (NMAX_FDCNG) but is used to quantize a vector of dimension 21(N_WB) shall now be described. FIG. 9 is similar to FIG. 7, but has two additional blocks, which are blocks 900 and 902. Unless otherwise described, the encoder 202 performs the same operations in blocks 104, 110-120, 122, and 700-704 shown in FIG. 9 as the corresponding blocks in FIG. 7 described above.

At block 700, the encoder 202 obtains the target vector of dimension 21 (e.g., a dimension shorter than the dimension used for codebook training). The input target vector of length N_WB may be obtained using the 3GPP EVS-codec analysis algorithm, as outlined in reference 3GPP TS 26.445 encoder.

In some embodiments, the input target_wb signal of dimension N_WB is transformed by a refined extrapolation method to dimension N_MAX_FDCNG by the encoder 202 to the FDNCG 24 input domain in operation 900. The extrapolation results in an extended input target of length N_MAX_FDCNG.

In a first operation, the FDCNG target_wb signal is extrapolated in the FDCNG domain by applying the shorter N=21 DCT type II transform as follows:

$$dct\_target \_wb = ( target\_wb ) ;$$

where target_wb has the dimension 21 (N_WB), and the applied DCT function is for the same dimension, i.e., as N_WB is lower than NMAX_FDCNG, an extra analysis DCT is executed using dimension N_WB(==21). This is to avoid storing several different DCT domain FD-CNG codebooks. The stored mantissa and scale factor values can thus be optimized for one single larger DCT length (e.g., 24), and save ROM-space.

In this example, the DCT-II(N_WB) is only executed as far as to obtain coefficients 0 to (Ntr_WB−1), where Ntr_WB is 18. This is to reduce the complexity of the additional DCT-II(N==21) analysis and the subsequent extrapolation. By not analyzing higher frequency components (e.g., upper basis vectors), truncation lengths other than Ntr_WB==18 can be used in this DCT analysis operation. However, it is pertinent to provide somewhat more detail in the target extrapolation than the truncation as used for the stored DCT(24) codebooks.

In this example, the DCT-II(N_WB==21) analysis is truncated after 18 coefficients (i.e., 85.7% of the full bandwidth), while the stored DCT-II(N==24) vectors are truncated at 75% of the bandwidth.

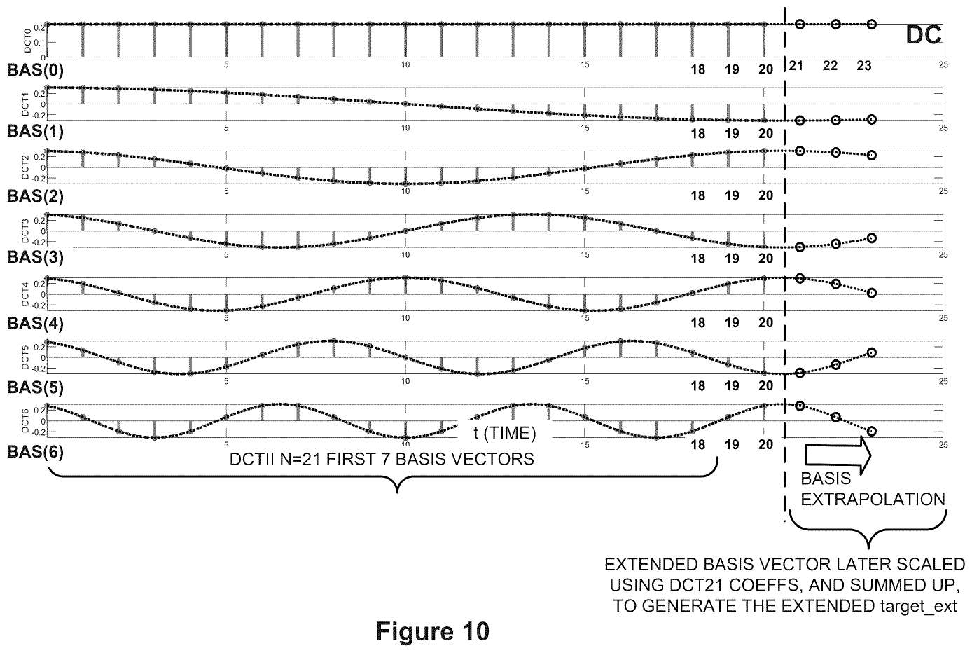

Referring to FIG. 10, DCT-II(N=21) is shown with Ntr_WB coefficients in dct_target_wb as a set of DCT-coefficients (i.e., the scale factors for the DCT's cosine basis vectors) of the input signal target_wb. For example, dct_target_wb[0] is the scaling of the DC basis vector ‘BAS[0]’ and dct_target_wb[6] is the scaling of the three period basis vector ‘BAS[6]’ shown in FIG. 10. There are also the DCT-II(N=21) basis vectors (which are used for extrapolation) available either as stored in a transform matrix bas(k, t) or alternatively by dynamically constructing the basis vectors using the IDCT(type II, N=N_WB) formula as follows:

```
for k=0 ... (Ntr_WB-1)
  scale=1/sqrt(2);
  if k==0 , scale=1.0; end
  for t=0 ... (N_WB-1)
      bas(k, t) = scale*sqrt(2/N_WB)*cos( (pi/(2*N))*(k)*(2*t + 1 ));
    end
end
```

Each available basis vector can be accessed as follows:
bas(k), k∈0 . . . (Ntr_WB−1), specifies the kₜₕ basis vector and where bas(k, t) indexes the full matrix using time index elements t∈0 . . . (N_WB−1) of each bas(k) basis vector.

Further, the input signal target_wb is now extended by (N_MAX_FDCNG−N_WB) samples by extrapolation using a subset of the DCT basis vectors, and scaling of each basis vector bas(k) by the corresponding DCT coefficient dct_target_wb(i), followed by a summation of the extended part of the basis vectors.

This extension/extrapolation ensures that the extended target_wb signal target_ext will maintain the primary frequency components in target_wb without adding undesired and unnecessary extension/extrapolation noise, which is responsible for causing a degraded overall VQ performance.

Other extrapolation methods like zero extension or last value repetition, interpolation or linear extrapolation or polynomial extrapolation will not maintain the cosine waveform content after DCT-II(24) analysis to the same degree. Preserving undistorted tonality as extended cosines in the extended signal is important as the subsequent transformation step (DCT-II(N==24)) is also based on cosine analysis.

Moreover, to save complexity, the target_wb signal may be reused for the initial part of the extended signal target_ext as follows:

$$target\_ext ( t ) = target\_wb ( t ) , t ∈ 0 … ( N\_WB - 1 )$$

Alternatively, this initial part can be recreated utilizing IDCT-II(N=N_WB) by using the available DCT coefficients up to coefficient (Ntr_WB-1).

Further, extension creation through scaled basis vector summation can be achieved. Due to the reflective nature of the DCT type II basis vectors, it is only the higher part of the basis vector that is actually used for the proposed extrapolation. In some embodiments, this may be achieved as follows:

| t_rev = N_WB; | |
|---|---|
| for ( t =N_WB . . . (N_MAX_FDCNG-1) ) | |
| { | |
| /* for each extension sample t */ | |
| /* t = 21 22 23; | // extension indices |
| t_rev = 20 19 18; | //dctII reflected basis vector indices |

```
    */
    target_ext(t) = 0;
    t_rev = t_rev − 1;
    for k = 0 . . . (Ntr_WB-1)/* for each avail- DCT basis k*/
    {
      /* DCT-coeff * reflected basis vector */
        target_ext(t) =target_ext(t) + dct_target_wb(k) * bas(k, t_rev);
        /* sum up scaled and extended basis vector */
    } /* end for k */
}/* end for t */
```

In a final operation, the extended target signal is copied to the full length target buffer as follows:

$$target ( t ) = target\_ext ( t ) , t ∈ 0 … ( N\_MAX \_FDCNG - 1 ) .$$

In some embodiments, the encoder 202 may now use the extended input signal target(t) to continue the search of a DCT-II (N=24) domain codebook in a manner described earlier starting in block 702.

In FIG. 10, the extrapolation method for the first seven unscaled DCT-II(N==21) basis vectors is outlined.

It should be noted that even though the extrapolation described here is performed in the incoming input normalized FDCNG envelope signal domain, the extrapolation can also equivalently be performed after mid subtraction and global scaling (i.e., after operation 702 or after operation 704 in FIG. 9). Notably, FIG. 10 illustrates a number of basis vectors that are initially extended and/or extrapolated, and subsequently scaled using DCT21 coefficients. These scaled basis vectors are then summed up to generate the extension part of the target as output.

The search process continues as previously described above in FIG. 7 for a N_MAX_FDCNG sized target vector and then fully proceeds to block 902 in FIG. 9, where the IDCT synthesis can be performed using a full vector length of N_MAX_FDCNG to be able to calculate the upper extended part error contribution.

In block 710 of FIG. 9, the residual calculation in preparation for stage #2 may be performed over the shorter N_WB samples.

In block 902, the MSE for each candidate is updated to properly reflect the reduced dimension N_WB mean square error (i.e., the core DCT-II(N==24) search, wherein the MSEs reflect an error in the extended DCT-II(N=24) domain and need to be updated for stage #2 and a forward search). In case there is a new worst candidate after this MSE update for dimension N_WB, the p_max index of the worst candidate is also updated.

In some embodiments, MSEs stored in the dist[Nc] vector are updated by subtracting the MSE contribution ext_err[c] for the extended parts, as follows:

```
for (c= 0; c < Nc ; c++) {
    idx_full = indices[c];
    if the synthesized candidate vector
      dec_vec[c][0 ...(N_MAX_FDCNG-1)] is not available; it is
      obtained by decoding vector idx_full,
  ext_err[c]=0.0; /*MSE in the extended part for candidate c */
  for ( t =N_WB . . . (N_MAX_FDCNG-1) ; t++ )
  {
    /* for each extension sample t */
    /* t = 21 22 23;
    ext_err[c] = ext_err[c] + (target_ext[t] − dec_vec[c][t])²
    } /* end for t */
  dist[c] = dist[c] − ext_err[c];
}/* end for c */
```

Further, p_max may be updated using p_max=maximum(dist, Nc). Notably, a new current worst candidate among all 8 (Nc) in the vector dist is established using the shorter dimensions N_WB MSEs.

In some embodiments, the first stage (e.g., stage #1) search part using DCT-II(N=24) stored codebook preparation for the second stage (e.g., stage #2) candidate indices may exit. As such, Nc candidate indices are available in indices[ ], and their MSEs for the shorter dimension N_WB are available in dist[Nc]. Further, p_max is pointing to the worst candidate from the first stage.

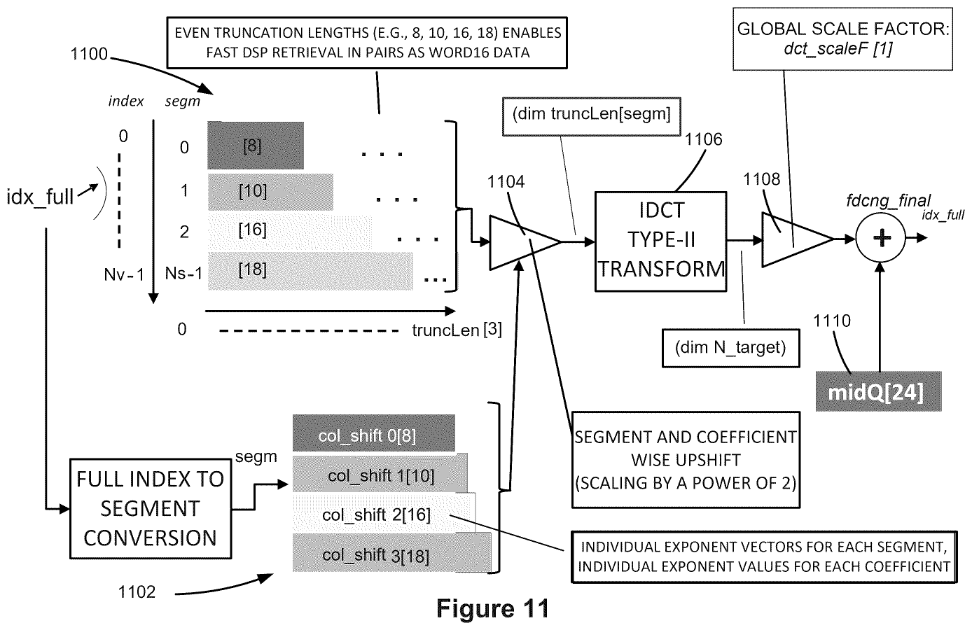

FIG. 11 illustrates an overall synthesis model that can be used in both an encoder and/or decoder. For example, FIG. 11 illustrates schematically the manner in which the encoder 202 may reconstruct the FD-CNG vector in operation 120. Turning to FIG. 11, the encoder 202 obtains the index idx_full in the range [0 . . . (Nv−1)]1100 which contains the Ns−1 segments and the corresponding column shift (e.g., described herein as ‘col_shift’) values 1102. In the case of a decoder, there would only be the fdcng_final_{idx_full} as described above.

The encoder 202 or decoder 212 performs a segment and coefficient wise upshift in operation 1104. In operation 1106, the encoder 202 or decoder 212 performs an inverse DCT Type II transform and scales the output down to the original unscaled FDCNG domain in operation 1108.

In operation 1110, the mid-stage #1 codebook vector (i.e., illustrated as midQ[24] vector) is added back to the vector to output and/or produce the fdcng_final_{idx_full} vector.

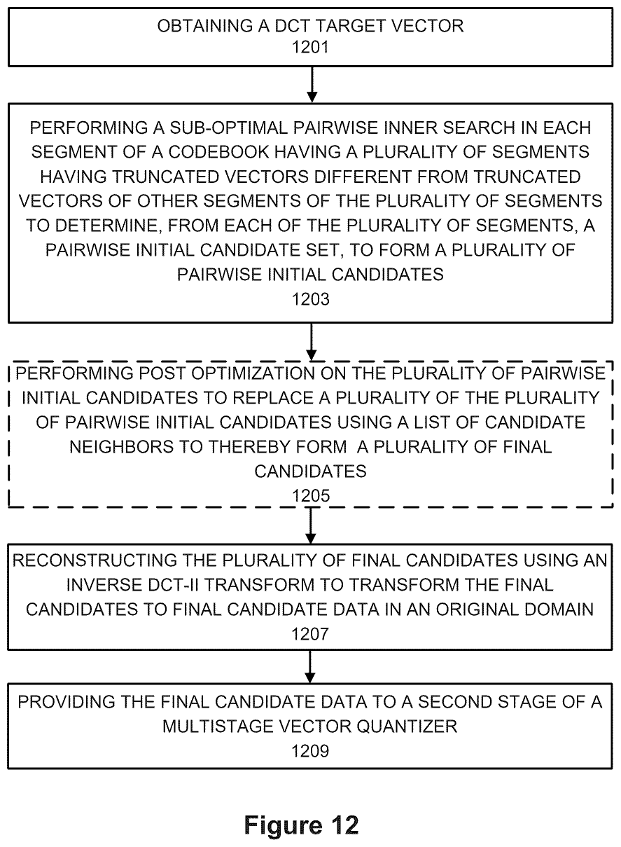

Operations of the encoder 202 (e.g., implemented using the structure of the block diagram of FIG. 3) will now be discussed with reference to the flow chart of FIG. 12 according to some embodiments of inventive concepts. For example, modules may be stored in memory 310 of FIG. 3, and these modules may provide instructions so that when the instructions of a module are executed by respective encoder processing circuitry, the encoder 202 performs respective operations of the flow chart.

FIG. 12 illustrates operations the encoder 202 performs according to some embodiments. Referring to FIG. 12, in block 1201, the encoder 202 obtains a DCT target vector (e.g., ‘dct_target’ vector).

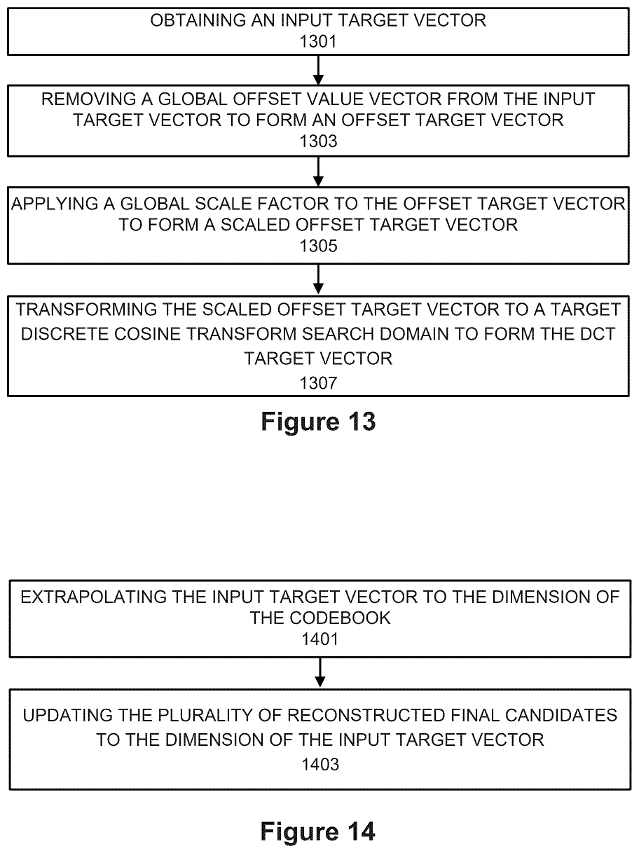

In some embodiments, the operations of block 1201 can be collectively represented by blocks 1301-1307 of FIG. 13. More specifically, FIG. 13 illustrates operations the encoder 202 performs according to some embodiments to obtain the dct_target vector. Referring to FIG. 13, in block 1301, the encoder 202 obtains an input target vector. In block 1303, the encoder 202 removes a global offset value vector (e.g., a midvalue vector) from the input target vector to form an offset target vector. In block 1305, the encoder 202 applies a global scale factor to the offset target vector. In block 1307, the encoder 202 transforms the offset target vector to a target discrete cosine transform search domain to form the dct_target vector.

As previously described, the input target vector used in obtaining the dct_target vector may have a different dimension than the dimension of the codebook 104. As illustrated in block 1401 of FIG. 14, the encoder 202 extrapolates the input target vector to the dimension of the codebook. In some embodiments, the encoder 202 extrapolates the input target vector to the dimension of the codebook by extrapolating the input target vector through extensions of input domain basis vectors for the DCT transform used. In some embodiments, the extensions of input domain basis vectors for the DCT transform used are based on a subset of input domain basis vectors.

Returning to FIG. 12, in block 1203, the encoder 202 performs a sub-optimal pairwise inner search in each segment of a codebook 104 having a plurality of segments with each segment having truncated vectors different from truncated vectors of other segments of the plurality of segments to determine, from each of the plurality of segments, a pairwise initial candidate set to form a plurality of pairwise initial candidates from the sub-optimal pairwise inner searches.

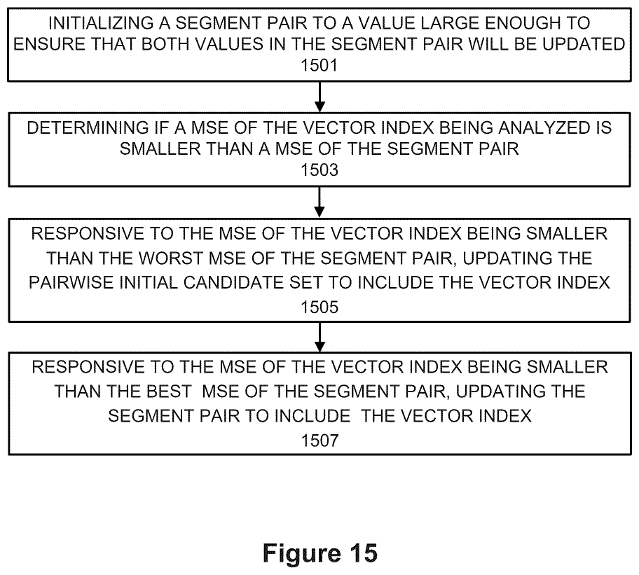

FIG. 15 illustrates an example embodiment of performing the sub-optimal pairwise inner search in the codebook 104 (as indicated in block 1203 of FIG. 12). Turning to FIG. 15, in block 1501, the encoder 202, for each segment of the plurality of segments, initializes a segment pair to a value large enough to ensure that both values in the segment pair will be updated.

In block 1503, the encoder 202, for each vector index in each segment, determines if a mean square error (MSE) of the vector index being analyzed is smaller than a MSE of the segment pair.

In block 1505, the encoder 202, responsive to the MSE of the vector index being smaller than the worst MSE of the segment pair, updates the pairwise initial candidate set to include the vector index. In block 1507, the encoder 202, responsive to the MSE of the vector index being smaller than the best MSE of the segment pair, updates the segment pair to include the vector index.

Alternatively and in some embodiments, the encoder 202, responsive to the MSE of the current vector being higher than the worst MSE of the segment pair, does not update the segment pair to include the vector index. Returning to FIG. 12, in block 1205, the encoder 202 (optionally) performs post optimization on the plurality of pairwise initial candidates to replace a plurality of the plurality of pairwise initial candidates using a list of candidate neighbors to thereby form a plurality of pairwise final candidates.

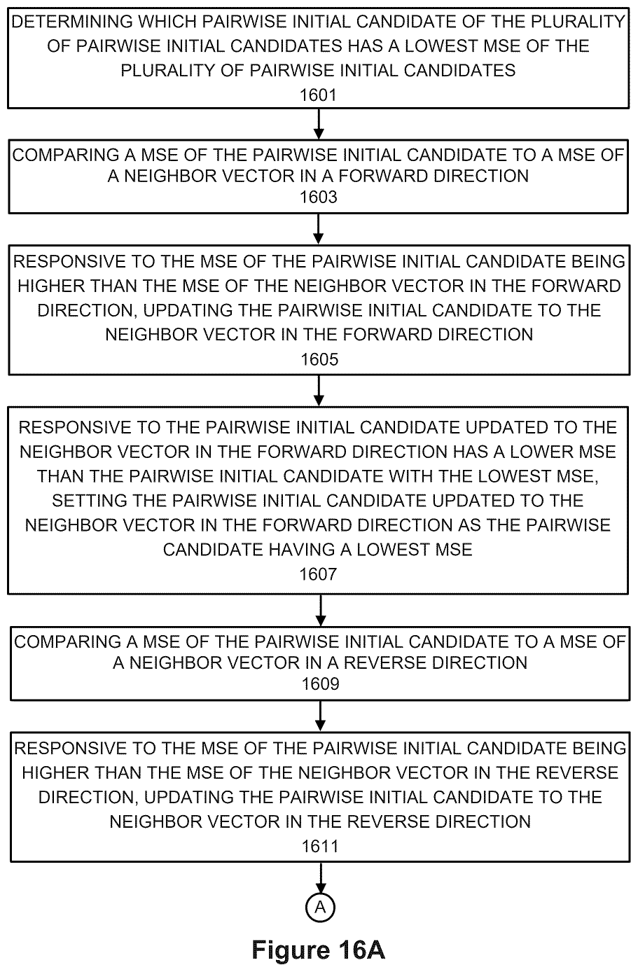

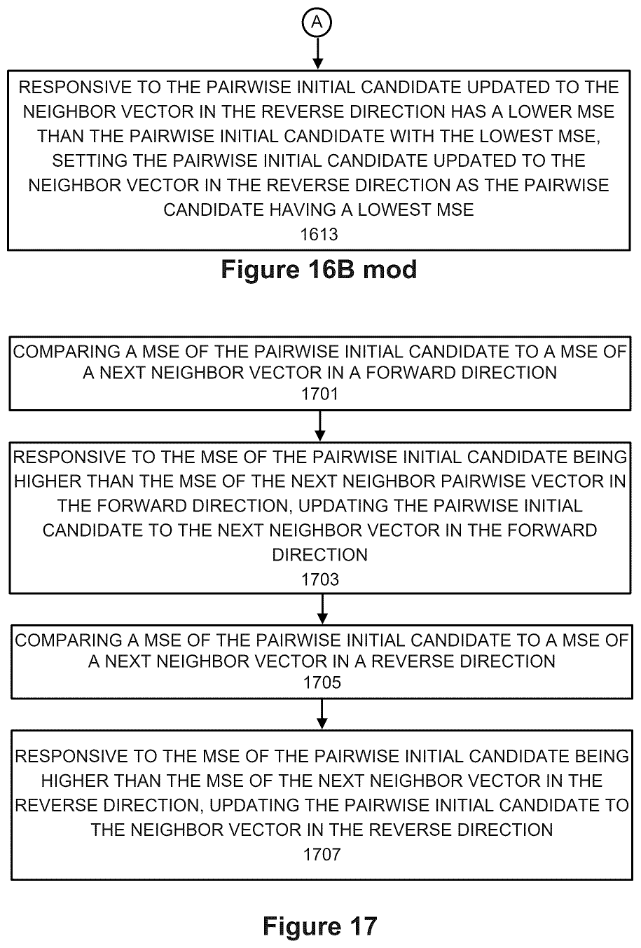

FIGS. 16A-16B illustrates an example embodiment of performing the post optimization (e.g., as indicated in block 1205 of FIG. 12). Turning to FIG. 16A, in block 1601, the encoder 202 determines which pairwise initial candidate of the plurality of pairwise initial candidates has a lowest MSE of the plurality of pairwise initial candidates. For each pairwise initial candidate other than the pairwise initial candidate with the lowest MSE, the encoder 202 performs the operations of blocks 1603 to 1613.

In block 1603, the encoder 202 compares a MSE of the pairwise initial candidate to a MSE of a neighbor vector in a forward direction.

In block 1605, the encoder 202, responsive to the MSE of the pairwise initial candidate being higher than the MSE of the neighbor vector in the forward direction, updates the pairwise initial candidate to the neighbor vector in the forward direction.

In block 1607, the encoder 202, responsive to the pairwise initial candidate updated to the neighbor vector in the forward direction has a lower MSE than the pairwise initial candidate with the lowest MSE, sets the pairwise initial candidate updated to the neighbor vector in the forward direction as the pairwise candidate having a lowest MSE.

In block 1609, the encoder 202 compares the MSE of the pairwise initial candidate to a MSE of a neighbor vector in a reverse direction. In block 1611, the encoder 202, responsive to the MSE of the pairwise initial candidate being higher than the MSE of the neighbor vector in the reverse direction, updates the pairwise initial candidate to the neighbor vector in the reverse direction.

Turning to FIG. 16B, in block 1613, the encoder 202, responsive to the pairwise initial candidate updated to the neighbor vector in the reverse direction has a lower MSE than the pairwise initial candidate with the lowest MSE, sets the pairwise initial candidate updated to the neighbor vector in the reverse direction as the pairwise candidate having a lowest MSE.

In some embodiments, the pairwise initial candidates are compared to a next neighbor vector in the forward direction and the reverse direction. This is illustrated in FIG. 17. Turning to FIG. 17, in block 1701, the encoder 202 compares the MSE of the pairwise initial candidate to a MSE of a next neighbor vector in the forward direction.

In block 1703, the encoder 202, responsive to the MSE of the pairwise initial candidate being higher than the MSE of the next neighbor vector in the forward direction, updates the pairwise initial candidate to the next neighbor vector in the forward direction.

In block 1705, the encoder 202 compares the MSE of the pairwise initial candidate to a MSE of a next neighbor vector in the reverse direction.

In block 1707, the encoder 202, responsive to the MSE of the pairwise initial candidate is higher than the MSE of the next neighbor vector in the reverse direction, update the pairwise initial candidate to the next neighbor vector in the reverse direction.

In some embodiments, the next neighbor vector and the neighbor vector in the forward direction are part of a forward circular MSE neighboring index list and the next neighbor vector and the neighbor vector in the reverse direction are part of a reverse circular MSE neighboring index list. The forward circular MSE neighboring index list and the reverse circular MSE neighboring index list are created based on a vector ordering mse_order_circ of length Nv across all the plurality of segments in a full concatenated codebook cb_temporary_full.

Returning to FIG. 12, in block 1207, the encoder 202 reconstructs the plurality of pairwise final candidates using an inverse type II discrete cosine transform, DCT-II, to transform the plurality of pairwise final candidates to an original domain.

As previously described, the input target vector used in obtaining the dct_target vector may have a different dimension than the dimension of the codebook 104. As illustrated in block 1403 of FIG. 14, when this occurs, the encoder 202 updates the plurality of reconstructed candidates to the dimension of the input target vector.

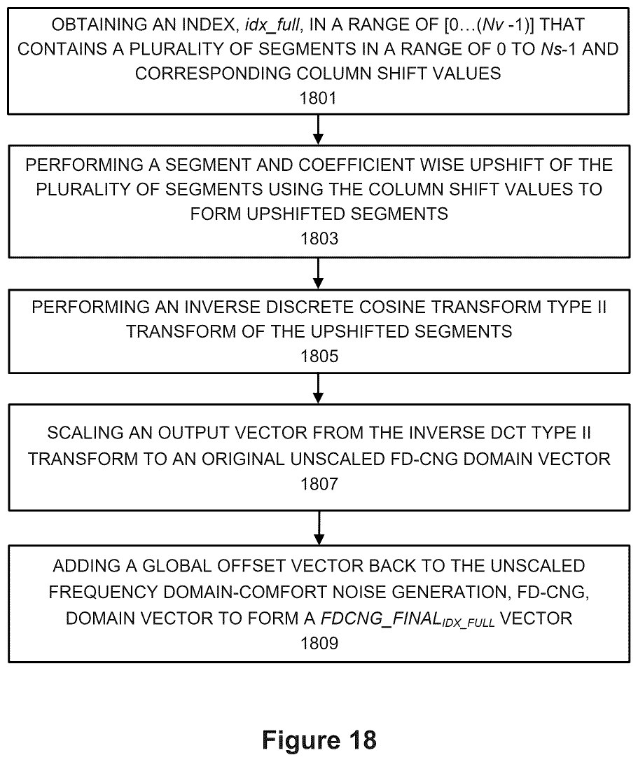

FIG. 18 illustrates an example embodiment of reconstructing the plurality of pairwise final candidates. Turning to FIG. 18, in block 1801, the encoder 202 obtains an index idx_full in the range [0 . . . (Nv−1)]1100 which contains a plurality of segments in a range of 0 to Ns−1, and a corresponding column shift values, e.g., col_shift values 1102.

In block 1803, the encoder 202 performs a segment and coefficient based upshift. In block 1805, the encoder 202 performs an inverse discrete cosine transform (DCT) Type II transform. In block 1807, the encoder 202 scales an output vector from the DCT Type II transform down to an original unscaled FD-CNG domain vector. In some embodiments, the scaling can include scaling up or scaling down.

In block 1809, the encoder 202 adds the global offset value vector (e.g., a midvalue and/or a mid-stage #1 codebook vector) back to the unscaled FD-CNG domain vector to form the fdcng_final_{idx_full} vector.

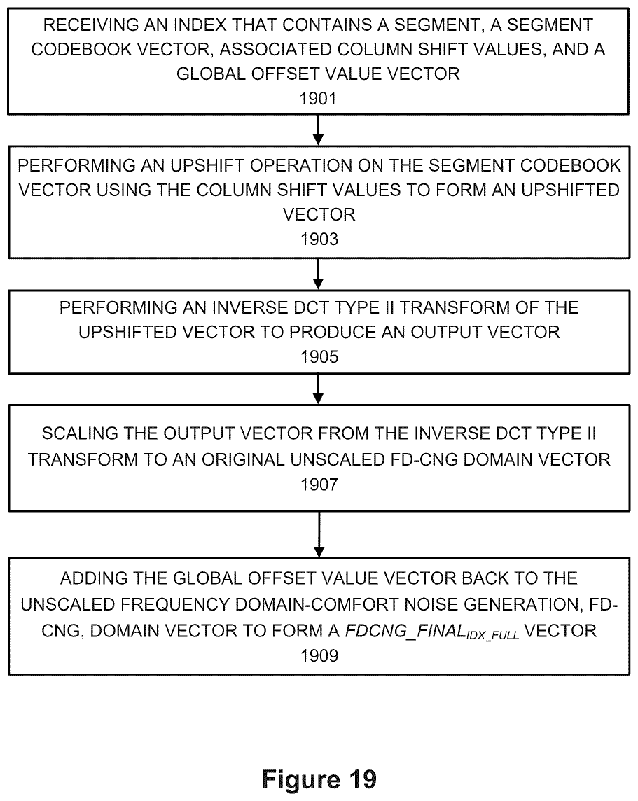

A similar reconstruction can be done in the decoder 212. This is depicted in FIG. 19. Turning to FIG. 19, in block 1901, the decoder 212 receives an index that corresponds to a segment, a segment codebook vector (e.g., a mantissa value vector), associated column shift values, and a global offset value vector.

In block 1903, the decoder 212 performs an upshift operation on the segment codebook vector using the column shift values to form an upshifted vector. In block 1905, the encoder 202 performs an inverse DCT Type II transform of the upshifted vector to produce an output vector. In block 1907, the decoder 212 scales the output vector from the Inverse DCT Type II transform down to an original unscaled FD-CNG domain vector.

In block 1909, the decoder 212 adds the global offset vector (e.g., a mid-vector) back to the unscaled FD-CNG domain vector to form a final output vector (e.g., a fdcn_final_{idx_full} vector and/or a final FDCNG domain vector).

Summary of ROM savings in the encoder embodiments described above.

Total ROM Word8 storage in proposal is sum([128 170 272 1404)=1974 bytes.

Forward and reverse circular list vectors for enhanced search adds 128 Word8 each, i.e., +256 bytes.

Total ROM Storage of original LBG codebook was 3072 Word16=6144 bytes

Total ROM Storage of original LBG codebook 3072 single precision float=9216 bytes.

Approximately Table ROM reduction is (6144−(1974+256))/6144=>approx. 63%.

Summary of WMOPS savings in cycles (operations) in the encoder embodiments described above.

The number of inner loop coefficients to process has been reduced by 30% (from 3072 to 1974)

The inner best MSE update loop(run 128 times) has been optimized (using pairs) to only use 7-8 cycles.

Notably, reference uses in the worst case approximately ~35 cycles to maintain and update the list of best Nc=8 candidates. Thus, a saving of (35−7)=28 ops (or cycles) can be expected in the worst case (WC) for the update of the best candidate.

In the proposal the MSE calculation for each vector is increased by lop*tLen, due to the upshift of the coefficient mantissa, and the saving of each index's MSE costs 2 ops, however this increase (1 op*tLen+2 ops) is always lower than the WC saving of the best MSE update loop (28).

Similar inner loop MSE savings can be achieved for using the codebook 104 created for e.g., dimension 24 (NMAX_FDCNG) when used for target vectors of different dimensions (e.g., N_WB).

Although the computing devices described herein (e.g., decoders, audio object renderers, encoders, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally. Although the computing devices described herein (e.g., UEs, encoders, decoders, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

Below are presented a plurality of example Tables used in the detailed description in the various embodiments. For example, Table 4 illustrates an example global scaling and global subtraction table. Notably, the second row of Table 4 exemplify global scaling constants, whereas the third row illustrates an example offset vector.

TABLE 4
/* scaling constants */
const float dct_scaleF[3] = { 0.420288085937500f , (0.420288085937500f / 16.0f) ,
(0.420288085937500f * 0.420288085937500f) / (16.0f* 16.0f) };
const float dct_invScaleF[2] = { 2.379272460937500f ,2.379272460937500f* 16.0f
};
const float midQ[FDCNG_VQ_MAX_LEN] = { /* from Q10 */
+1.791894531250000e+01f, +1.285449218750000e+01f,
+1.083789062500000e+01f, +9.636718750000000e+00f,
+6.597656250000000e+00f, +4.524414062500000e+00f,
+4.312500000000000e+00f, +2.365234375000000e+00f,
+3.266601562500000e+00f, +2.623046875000000e+00f, +3.173828125000000e−01f,
−5.703125000000000e−01f, −4.082031250000000e−01f, −2.376953125000000e+00f, −
5.624023437500000e+00f, −5.287109375000000e+00f,
−9.312500000000000e+00f, −9.365234375000000e+00f, −1.283691406250000e+01f,
−1.393066406250000e+01f, −1.420605468750000e+01f, −1.591015625000000e+01f,
−1.729687500000000e+01f, −1.734179687500000e+01f
};

### Segment Codebooks for MSVQ Stage #1

Total ROM Word8 storage is sum([128 170 272 1404)=1974 bytes.

In some embodiments, examples of the aforementioned segment codebooks are illustrated in Table 5. Notably, these segment codebooks may comprise “optimized” segment codebooks that include a mantissa limit of 8 and an exponent that is not significantly limited. For example, these segment codebooks may be signal-to-noise ratio (SNR) limited or granularity limited.

```
TABLE 5
const Word8 /*segm 0, 16 x 8 */ cb_segmW8[0][16][8] /*[128]*/ = {
      29, −126, 8, −34, −45, −42, −13, 2,
      22, −120, 0, −27, −41, −50, −25, 42,
      20, −116, −2, −39, −61, −33, −22, −25,
      28, −115, 9, −42, −39, −28, −12, −25,
      16, −111, −6, −29, −34, −53, −21, 19,
      18, −105, −2, −44, −44, −30, −17, −26,
      10, −100, −12, −27, −73, −19, −25, −14,
      32, −100, 14, −15, −13, −4, 7, 5,
      18, −68, 6, −15, −36, −9, −3, −4,
    −76, 57, −75, −36, −2, 21, 11, −13,
    −66, 61, −58, −74, 17, 13, 7, −23,
      20, 93, 54, 32, 72, 5, 23, 55,
    −36, 110, −16, 37 39, 30, 64, −4,
    −33, 118, −7, 22, 67, 21, 60, 2,
        7, 121, 41, 16, 72, 98, 43, 50,
    −17, 125, 6, 74, 21, 85, 5, 98
};
const Word8 /*segm 1, 17 x 10 */ cb_segmW8[1][17][10]/*[170]*/= {
      20, −127, −12, −9, 1, −30, −2, −1, −43, −54,
      24, −113, 3, −39, −49, −25, −15, −27, 6, 2,
      55, 17, 74, 22, 78, 77, 87, 97, 89, 61,
    −76, 29, −85, −17, −40, −13, −30, 12, −56, 60,
      49, 35, 72, 8, 69, 75, 81, 76, 64, 37,
        2, 66, 20, 1, −3, 62, −13, 78, −20, 16,
      30, 80, 60, 31, 114, 67, 46, 70, 92, 67,
        0, 83, 27, −36, −6, 95, 34, 46, 4, 38,
    −27, 85 −9, −3, −36, 50, 2, 14, −33, 37,
    −12, 88, 12, −10, −34, 45, −26, 42, −39, 22,
    −25, 101, 1, 13, 92, −6, 81, −9, 35, 77,
      11, 102, 44, 20, 85, 10, 15, 24, 18, 35,
      11, 111, 46, 3, 88, 88, 44, 50, −4, 66,
    −20, 114, 13, 8, 83, 1, 61, 31, 56, 98,
        0, 120, 33, 14, 70, 82, 44, 23, −1, 53,
    −24, 124, −3, 66, 6, 83, 1, 85, −8, 70,
      −8, 127, 23, 24, 58, 89, 46, 20, 14, 54
};
const Word8 /*segm 2 , 17 x 16 */ cb_segmW8[2][17][16] /*[272]*/ = {
    32 ,−69 , 21 ,3 , −9 , 17 ,3 , 14 , 15 , 35 ,−17 ,−10 ,−20 , 28 ,−52 ,−19,
    24 ,−49 , 17 ,9 , −6 , 14 , 22 , 33 , 51 , 38 , 21 , 14 ,5 , 38 , 13 , −5,
    27 , −8 , 30 ,9 , 93 , 65 , 65 , 66 , 67 , 30 , 39 , 21 ,9 , 22 ,5 ,−17,
  −38 , 21 ,−38 ,−40 ,−65 , 16 ,−32 ,−6 ,−56 , 23 ,−47 ,−24 ,−41 , −7 ,−11 ,−63,
  −28 , 26 ,−30 , 20 ,−62 , 40 , −4 ,0 , −4 , 29 ,−45 , 12 ,−16 ,2 ,−11 ,−11,
  −66 , 29 ,−72 ,−40 ,−30 , 18 ,−20 , 34 ,−21 , 52 ,−57 , −3 ,−29 ,−15 ,0 ,−64,
  −50 , 32 ,−49 ,−46 ,−30 , 13 ,−27 , 41 ,−35 , 56 ,−45 ,−19 ,−43 , −5 , 31 ,−72,
  −39 , 52 ,−30 ,−36 , 12 , 20 , −7 ,9 , −6 , 20 ,−29 ,−22 ,−41 ,−11 ,−37 ,−61,
    35 , 68 , 66 , 26 , 42 , 10 , 10 , 39 , 42 , 62 , 42 , 12 , 20 , 50 , 33 , 24,
  −16 , 71 , −7 , 19 , 42 , 56 ,−14 ,8 ,−33 ,6 ,0 ,−18 ,−38 , 41 , 32 ,−17,
    50 , 72 , 85 , 29 , 48 , 38 , 21 , 53 , 92 , 81 , 60 , 25 , 37 , 66 , 67 , 42,
  −48 , 77 ,−32 ,−56 ,−51 ,2 ,−35 , −4 , −1 ,−19 ,−46 ,−28 ,−56 , 13 ,−57 ,−16,
    −1 ,102 , 29 , 27 , 81 ,2 , 29 , 17 ,2 , 29 ,−18 ,−23 , 53 , 58 , 29 , 20,
    22 ,104 , 51 , 74 ,−27 , 79 ,−21 , 89 , 82 , 51 ,106 ,−33 ,101 , 29 ,123 , 12,
  −16 ,112 , 14 , 19 , 67 ,−10 , 24 ,−16 , −1 , 43 ,−15 ,−30 , 29 , 53 , 55 , 24,
    13 ,114 , 47 , 63 , 10 , 55 , −4 , 98 , 67 , 58 , 83 ,−40 , 66 ,9 , 34 , −9,
      4 ,117 , 37 , 43 , 44 , 32 , 13 , 75 , 32 , 33 , 15 ,−70 , 51 , 39 , 68 , 15
};
const Word8 /*segm 3, 78 x 18 */ cb_segmW8[3][78][18] /*[1404] */ = {
  21, −127, −23, −10, 7, −26, 1, 6, −39, −53, −19, −84, −34, 16, −10, −24, −75, 9,
  76, −117, 124, −63, 75, 72, −9, 115, 42, 100, −36, 120, −37, 66, 46, 72, −34, 18,
  24, −115, 3, −65, −47, −24, −7, −13, 1, −18, −10, −58, −30, 2, −37, −27, −78, 9,
  24, −115, 5, −76, −48, −30, −17, −25, −11, −9, −17, −62, −29, 4, −46, −24, −75, 8,
  24, −113, 8, −71, −53, −32, −20, −35, −5, −14, −4, −50, −25, 2, −47, −29, −82, 5,
  24, −113, 6, −71, −48, −27, −14, −26, −5, −14, −13, −67, −26, 5, −40, −24, −71, 8,
  22, −113, 2, −66, −49, −29, −16, −25, −5, −16, −11, −72, −25, 4, −43, −22, −75, 9,
  21, −110, 2, −72, −48, −28, −14, −23, −3, −12, −9, −62, −24, 4, −45, −25, −74, 9,
  20, −109, −4, −54, −56, −20, −9, −22, 10, −23, −4, −65, −30, 7, −54, −21, −90, 11,
  23, −109, 6, −61, −38, −22, −10, −13, 2, −9, −8, −62, −23, 8, −35, −22, −70, 10,
  18, −106, −11, −39, −62, −14, −9, −17, 11, −31, −2, −58, −29, 11, −57, −18, −96, 14,
  24, −105, 14, −85, −50, −26, −16, −26, 7, −5, −17, −77, −32, −6, −78, −37, −89, 4,
  26, −103, 19, −80, −49, −26, −18, −41, −12, −18, −21, −75, −32, −1, −60, −32, −86, 2,
  15, −103, −17, −31, −69, −12, −9, −20, 18, −37, 3, −65, −29, 12, −68, −14, −103, 16,
  19, −81, 9, −44, −40, −15, −5, −8, 9, 3, −12, −43, −25, 12, −27, −24, −55, 3,
  21, −80, 13, −37, −37, −13, −6, −10, 7, −2, −19, −45, −23, 15, −20, −21, −56, 4,
  16, −55, 14, −24, −35, −6, −1, 0, 14, 8, −5, −37, −22, 14, −21, −22, −50, 6,
  17, −54, 16, −19, −31, −3, 1, 2, 15, 8, −5, −34, −20, 16, −20, −21, −49, 8,
    9, −53, −8, 18, −1, 19, 18, 78, 13, 51, 6, 98, −5, 57, −23, 14, −44, 34,
  18, −48, 16, 32, −56, 11, −23, 19, −11, 17, −33, −18, −56, −8, −57, −3, −79, 14,
  15, −41, 18, −6, −27, 3, 3, 11, 19, 17, −2, −22, −17, 20, −14, −17, −47, 11,
  13, −40, 8, 49, 24, 12, 37, 71, 41, 51, 21, 67, −4, 46, 3, 11, −14, 31,
  38, −36, 80, 8, 21, 8, 17, 6, 28, 13, −9, −47, −30, −1, −50, −30, −64, 6,
  20, −34, 31, 47, 36, 20, 44, 68, 61, 43, 22, 36, 11, 28, 22, 1, −2, 15,
  26, −33, 45, 24, −4, −4, −18, −5, −14, 1, −37, −46, −45, 21, −60, −12, −61, 22,
  27, −32, 47, 55, 31, 28, 48, 67, 67, 45, 33, 53, 16, 30, 36, 1, 6, 20,
  28, −32, 56, 19, 13, 17, 29, 40, 48, 34, 8, 7, −5, 27, −2, −6, −24, 20,
  39, −30, 86, 6, 33, 14, 28, 27, 70, 32, 16, 10, 26, 37, −5, −13, 2, 22,
  13, −28, 20, 5, −24, 8, 5, 19, 22, 21, 1, −15, −18, 22, −14, −16, −49, 12,
  23, −24, 51, 0, 25, 17, 38, 50, 59, 39, 15, 22, 4, 32, 6, 0, −22, 22,
  29, −21, 71, −12, 19, 9, 35, 41, 64, 34, 13, 11, 6, 27, −3, −4, −23, 19,
  25, −18, 64, −36, 7, 8, 33, 40, 62, 19, 25, 35, 13, 32, −6, −12, 0, 28,
  −19, −18, −44, −68, −62, −18, −10, 22, −1, 47, −28, 35, −48, 36, −74, −5, −75, 17,
  18, −16, 49, −46, 7, 10, 30, 42, 63, 27, 19, 19, 3, 39, 11, −10, −18, 22,
  32, −15, 79, 10, 40, 26, 56, 77, 94, 65, 41, 65, 28, 47, 42, 17, 8, 31,
    4, −15, 15, −18, −88, −40, −65, −18, −61, 67, −79, 11, −70, 32, −87, −7, −101, 25,
  12, −15, 23, 18, −20, 15, 9, 30, 27, 26, 4, −11, −15, 25, −7, −13, −40, 13,
  −3, −14, −2, −15, −91, −47, −67, −17, −52, 71, −82, −5, −68, 28, −98, −8, −104, 22,
  15, −13, 27, −14, 79, 67, 62, 53, 66, 24, 21, 19, 2, 18, −1, −15, −27, 15,
  22, −11, 44, 4, 98, 75, 73, 78, 89, 44, 39, 39, 12, 27, 17, −7, −9, 22,
  −18, −11, −38, −60, −49, −4, 2, 40, 12, 56, −25, 46, −38, 44, −65, −1, −67, 20,
  31, −9, 59, 109, −19, 19, −22, −44, −42, −12, −81, −59, −87, 16, −101, −14, −91, 11,
  16, −7, 32, −15, 101, 82, 73, 71, 86, 40, 37, 32, 10, 21, 2, −14, −21, 19,
  27, −6, 58, 64, 26, 50, 25, 78, 50, 34, 17, 19, −15, 10, −38, −29, −66, 7,
  12, −5, 22, 7, 108, 74, 76, 79, 78, 29, 25, 8, 0, 16, −3, −13, −16, 20,
  −4, −4, 3, −34, −94, −48, −63, −27, −65, 69, −82, −9, −74, 27, −86, −11, −104, 26,
    6, −4, 11, −16, 104, 73, 76, 80, 81, 31, 20, −8, −10, 4, −22, −21, −32, 15,
  −15, −3, −28, −44, −28, 9, 13, 61, 32, 80, −1, 97, −16, 62, −41, 8, −49, 28,
    9, −1, 24, 27, −15, 21, 12, 40, 35, 36, 7, 5, −13, 30, −9, −10, −37, 17,
  19, −1, 39, 62, −33, 34, −10, 16, −3, −24, −44, −8, −40, 11, −35, −1, −89, 10,
  −12, −1, −13, −31, −99, −58, −64, −33, −59, 73, −85, −16, −77, 27, −92, −19, −100, 26,
  17, 0, 36, 11, 116, 85, 82, 92, 96, 39, 32, 12, −6, 13, −8, −18, −26, 17,
  10, 1, 19, −1, 123, 90, 88, 93, 84, 30, 26, 18, 6, 19, 5, −8, −8, 25,
  13, 1, 45, −16, −51, −33, −21, −3, 8, 33, −25, −2, −35, 38, −38, −17, −67, 15,
  15, 5, 24, 57, 0, 6, −85, −115, −72, −83, −106, −103, −55, −29, −122, −31, −73, −19,
  12, 7, 35, 29, −3, 20, 20, 37, 44, 35, 15, 2, −6, 29, 3, −10, −31, 15,
  −21, 9, −50, 94, −98, −88, −33, −45, −49, −100, −106, −27, 6, −69, −123, 63, −80, −79,
    7, 12, 25, 39, −18, 24, 11, 37, 30, 34, 6, −1, −14, 26, −12, −11, −43, 15,
  −28, 12, −63, −11, −10, 38, 21, 68, 19, 47, −14, 112, 19, 64, −52, −6, −35, 26,
  −16, 12, −36, 55, −64, 26, −19, −27, −7, 41, −44, 3, −34, −35, −61, −37, −79, 16,
  −7, 12, −4, −20, 8, 25, 19, 61, 18, 66, −21, 86, −20, 52, −40, 9, −28, 36,
  11, 13, 29, 79, −28, 26, −8, 19, −2, 11, −38, −16, −49, 7, −48, −9, −89, 7,
  −36, 17, −73, 70, −123, −98, −42, −73, −14, −11, −79, 83, −13, −7, −94, 19, −35, −54,
  13, 17, 56, −3, −38, −30, −30, 0, 2, 80, −20, 49, −33, 49, −29, −2, −66, 34,
    0, 19, 25, −15, −40, −29, −23, 5, 2, 79, −50, 30, −44, 42, −64, −12, −61, 19,
    2, 20, 23, 15, 5, 17, 27, 66, 58, 70, 7, 78, −13, 58, −3, 16, −33, 34,
  −12, 23, −16, 22, −62, 23, −16, −20, 4, 41, −47, 8, −40, −39, −78, −36, −73, 12,
    6, 25, 30, 55, −6, 33, 21, 59, 48, 49, 11, 28, −10, 35, −7, −2, −36, 23,
  −26, 26, −40, −65, 16, 12, 34, 28, 29, 17, 4, 14, −4, 26, −8, −23, −23, 15,
  18, 26, 44, 71, −9, −8, −88, −70, −96, −39, −102, −22, −101, 13, 7, 5, −74, 16,
  −18, 28, −21, −24, −62, 9, −27, 44, −1, 64, −51, 39, −55, 48, −59, 5, −78, 30,
  −6, 30, 6, 14, −54, 26, −9, −15, 12, 46, −40, 21, −39, −41, −71, −34, −57, 15,
  −14, 30, −13, −13, −47, 19, −17, 61, 15, 69, −38, 53, −47, 57, −46, 6, −66, 34,
  17, 31, 53, 107, 30, 45, 21, 70, 59, 29, 30, −43, 19, 5, −31, −33, −93, −11,
    6, 43, 38, 63, 5, 38, 29, 56, 59, 46, 29, 17, 3, 33, 17, −6, −19, 19,
  27, 62, 112, −65, 46, 80, 70, 20, 44, 30, −8, −24, −17, 2, −39, −28, −34, 11,
  29, 66, 119, −65, 47, 83, 73, 29, 46, 32, −6, −29, −15, 8, −29, −26, −37, 11,
    4, 92, 68, 2, 67, −9, 12, 77, 9, −47, 14, 23, −37, −30, −8, −1, −90, −27
};
```

The following Table 6 illustrates example segment scaling factors.

TABLE 6

```
const Word16 col_shift[0][8] = {
  4, 4, 4, 3, 2, 2, 2, 1
};
const Word16 col_shift[1][10] = {
  4, 4, 4, 3, 2, 2, 2, 1,
  1, 1
};
const Word16 col_shift[2] [16] = {
  4, 4, 4, 3, 2, 2, 2, 1,
  1, 1, 1, 1, 1, 1, 0, 1
};
const Word16 col_shift[3][18] = {
  4, 4, 3, 2, 2, 2, 2, 1,
  1, 1, 1, 0, 1, 1, 0, 1,
  0, 1
};
```

### Circular Ordering Vectors

The following Table 7 illustrates an example MSE sorted circular neighborhood table (i.e., mse_order_circ[ ]) for the codebooks indicated above. Notably, Table 7 was created using a solution to the TSP problem (e.g., a closed-loop TSP problem) with a Convex-Hull approach. Table 7 further includes neighb_mnse_fwd which is a forward neighbor vector that is mentioned above and is a preferred way of traversing the circular MSE neighbor list in the forward direction. Further, Table 7 also includes neighb_imse_rev which is a reverse vector that is mentioned above in the description and is the preferred way of traversing the circular MSE neighbor list, in the reverse direction.

TABLE 7

```
const Word8 mse_order_circ[128] = {
  22, 43, 41, 126, 125, 20, 18, 51,
    7, 59, 52, 50, 16, 1, 0, 3
  62, 61, 54, 53, 55, 56, 57, 17,
    2, 4, 5, 58, 60, 63, 6, 64,
  65, 8, 33, 72, 77, 84, 76, 34,
  69, 74, 91, 104, 119, 123, 46, 48,
  49, 15, 31, 32, 30, 14, 28, 27,
  11, 127, 45, 47, 29, 13, 12, 26,
  23, 21, 25, 24, 42, 124, 93, 35,
  89, 92, 101, 102, 96, 94, 88, 83,
  81, 80, 79, 75, 73, 71, 68, 66,
  67, 70, 78, 86, 99, 111, 113, 103,
  85, 87, 100, 95, 98, 105, 107, 117,
  115, 110, 114, 121, 122, 120, 116, 109,
  106, 112, 82, 90, 97, 108, 37, 118,
  40, 44, 10, 9, 19, 38, 39, 36
};
const Word8 neighb_mse_fwd[128] = {
    3, 0, 4, 62, 5, 58, 64, 59,
  33, 19, 9, 127, 26, 12, 28, 31,
    1, 2, 51, 38, 18, 25, 43, 21,
  42, 24, 23, 11, 27, 13, 14, 32,
  30, 72, 69, 89, 22, 118, 39, 36,
  44, 126, 124, 41, 10, 47, 48, 29,
  49, 15, 16, 7, 50, 55, 53, 56,
  57, 17, 60, 52, 63, 54, 61, 6,
  65, 8, 67, 70, 66, 74, 78, 68,
  77, 71, 91, 73, 34, 84, 86, 75,
  79, 80, 90, 81, 76, 87, 99, 100,
  83, 92, 97, 104, 101, 35, 88, 98,
  94, 108, 105, 111, 95, 102, 96, 85,
  119, 107, 112, 117, 37, 106, 114, 113,
  82, 103, 121, 110, 109, 115, 40, 123,
  116, 122, 120, 46, 93, 20, 125, 45
};
const Word8 neighb_mse_rev[128] = {
    1, 16, 17, 0, 2, 4, 63, 51,
  65, 10, 44, 27, 13, 29, 30, 49,
  50, 57, 20, 9, 125, 23, 36, 26,
  25, 21, 12, 28, 14, 47, 32, 15,
  31, 8, 76, 93, 39, 108, 19, 38,
  118, 43, 24, 22, 40, 127, 123, 45,
  46, 48, 52, 18, 59, 54, 61, 53,
  55, 56, 5, 7, 58, 62, 3, 60,
    6, 64, 68, 66, 71, 34, 67, 73,
  33, 75, 69, 79, 84, 72, 70, 80,
  81, 83, 112, 88, 77, 103, 78, 85,
  94, 35, 82, 74, 89, 124, 96, 100,
  102, 90, 95, 86, 87, 92, 101, 113,
  91, 98, 109, 105, 97, 116, 115, 99,
  106, 111, 110, 117, 120, 107, 37, 104,
  122, 114, 121, 119, 42, 126, 41, 11
};
```

1. A method performed by an encoder, the method comprising:
obtaining a discrete cosine transform, DCT, target vector;
performing a sub-optimal pairwise inner search in each segment of a codebook having a plurality of segments with each segment having truncated vectors different from truncated vectors of other segments of the plurality of segments to determine, from each of the plurality of segments, a pairwise initial candidate set to form a plurality of pairwise initial candidates from the sub-optimal pairwise inner searches, wherein the DCT target vector is a target of the sub-optimal pairwise inner search in each of the plurality of segments;
reconstructing the plurality of final candidates using an inverse type II discrete cosine transform, DCT-II, to transform the plurality of final candidates to final candidate data in an original domain; and
providing the final candidate data to a second stage of a multistage vector quantizer.

2. The method of claim 1, wherein the plurality of segments comprises four segments.

3. The method of claim 1, wherein obtaining the DCT target vector comprises:
obtaining an input target vector;
removing a global offset value vector from the input target vector to form an offset target vector;
applying a global scale factor to the offset target vector to form a scaled offset target vector;
transforming the scaled offset target vector to a target discrete cosine transform search domain to form the DCT target vector.

4. The method of claim 3, further comprising:
responsive to the input target vector having a dimension different from a dimension of the codebook:
extrapolating the input target vector to the dimension of the codebook; and
wherein transforming the plurality of final candidates to a plurality of reconstructed final candidates in an original domain comprises updating the plurality of reconstructed candidates to the dimension of the input target vector.

5. The method of claim 4, wherein extrapolating the input target vector to the dimension of the codebook comprises extrapolating the input target vector through extensions of input domain basis vectors for the DCT transform used.

6. The method of claim 5, wherein the extensions of input domain basis vectors for the DCT transform used are based on a subset of input domain basis vectors.

7. The method of claim 1, wherein performing the sub-optimal pairwise inner search comprises:
for each segment of the plurality of segments, initializing a segment pair to a value large enough to ensure that both values in the segment pair will be updated;
for each vector index in each segment:
determining if a mean square error, MSE, of the vector index being analyzed is smaller than a MSE of the segment pair;
responsive to the MSE of the vector index being smaller than the worst MSE of the segment pair, updating the pairwise initial candidate set to include the vector index;
responsive to the MSE of the current vector being smaller than the best MSE of the segment pair, updating the segment pair to include the vector index.

8. The method of claim 1, wherein performing post optimization on the plurality of pairwise initial candidates comprises:
determining which pairwise initial candidate of the plurality of pairwise initial candidates has a lowest mean square error, MSE, of the plurality of pairwise initial candidates;
for each pairwise initial candidate other than the pairwise initial candidate with the lowest MSE:
comparing a MSE of the pairwise initial candidate to a MSE of a neighbor vector in a forward direction;
responsive to the MSE of the pairwise initial candidate being higher than the MSE of the neighbor vector in the forward direction, updating the pairwise initial candidate to the neighbor vector in the forward direction;
responsive to the pairwise initial candidate updated to the neighbor vector in the forward direction has a lower MSE than the pairwise initial candidate with the lowest MSE, setting the pairwise initial candidate updated to the neighbor vector in the forward direction as the pairwise candidate having a lowest MSE;
comparing the MSE of the pairwise initial candidate to a MSE of a neighbor vector in a reverse direction;
responsive to the MSE of the pairwise initial candidate is higher than the MSE of the neighbor vector in a reverse direction, updating the pairwise initial candidate to the neighbor vector in the reverse direction;
responsive to the pairwise initial candidate updated to the neighbor vector in the reverse direction has a lower MSE than the pairwise initial candidate with the lowest MSE, setting the pairwise initial candidate updated to the neighbor vector in the reverse direction as the pairwise candidate having a lowest MSE.

9. The method of claim 8, further comprising:
comparing the MSE of the pairwise initial candidate to a MSE of a next neighbor vector in the forward direction;
responsive to the MSE of the pairwise initial candidate is higher than the MSE of the next neighbor vector in the forward direction, updating the pairwise initial candidate to the next neighbor vector in the forward direction;
comparing the MSE of the pairwise initial candidate to a MSE of a next neighbor vector in the reverse direction;
responsive to the MSE of the pairwise initial candidate is higher than the MSE of the next neighbor vector in the reverse direction, updating the pairwise initial candidate to the next pairwise vector in the reverse direction.

10. The method of claim 8, wherein the next neighbor vector and the neighbor vector in the forward direction are part of a forward circular MSE neighboring index list and the next neighbor vector and the neighbor vector in the reverse direction are part of a reverse circular MSE neighboring index list.

11. The method of claim 10, wherein the forward circular MSE neighboring index list and the reverse circular MSE neighboring index list are created based on a vector ordering mse_order_circ of length Nv across all the plurality of segments in a full concatenated codebook cb_temporary_full.

12. The method of claim 1, wherein reconstructing the plurality of pairwise final candidates comprises:
obtaining an index, idx_full, in a range of [0 . . . (Nv−1)] that contains a plurality of segments in a range of 0 to Ns−1 and corresponding column shift values;
performing a segment and coefficient wise upshift of the plurality of segments using the column shift values for the index to form upshifted segments;
performing an inverse discrete cosine transform, DCT, Type II transform of the upshifted segments;
scaling an output vector from the inverse DCT Type II transform to an original unscaled FDCNG domain vector; and
adding a global offset value vector back to the unscaled frequency domain-comfort noise generation, FD-CNG, domain vector to form a fdcng_final_{idx_full} vector.

13. The method of claim 1 wherein the truncated vectors include vector segments having different degrees of high frequency content as compared to other segments.

14. The method of claim 1 wherein the final candidate data includes one or more of vector indices, reconstructed candidate vectors, and/or transformed codebook entries.

15. The method of claim 1 further comprising performing post optimization on the plurality of pairwise initial candidates to replace a plurality of the plurality of pairwise initial candidates using a list of candidate neighbors to thereby form a plurality of final candidates.

16. A method in a decoder to reconstruct a target vector, the method comprising:
receiving an index that corresponds to a segment, associated column shift values, a segment codebook vector, and a global offset value vector;
performing an upshift operation on the target vector using the column shift values to form an upshifted vector;
performing an inverse discrete cosine transform, DCT, Type II transform of the upshifted vector to produce an output vector;
scaling the output vector from the inverse DCT Type II transform to an original unscaled frequency domain-comfort noise generation, FDCNG, domain vector; and
adding the global offset value vector back to the unscaled FD-CNG domain vector to form a fdcng_final_{idx_full} vector.

17-18. (canceled)

19. An encoder adapted to:
obtain a discrete cosine transform, DCT, target vector;
perform a sub-optimal pairwise inner search in each segment of a codebook having a plurality of segments with each segment having truncated vectors different from truncated vectors of other segments of the plurality of segments to determine, from each of the plurality of segments, a pairwise initial candidate set to form a plurality of pairwise initial candidates from the sub-optimal pairwise inner searches, wherein the DCT target vector is a target of the sub-optimal pairwise inner search in each of the plurality of segments;
reconstruct the plurality of final candidates using an inverse type II discrete cosine transform, DCT-II, to transform the plurality of final candidates to final candidate data in an original domain; and
provide the final candidate data to a second stage of a multistage vector quantizer.

20. The encoder of claim 19, wherein the plurality of segments comprises four segments.

21. The encoder of claim 19, being adapted to obtain the DCT target vector by:
obtaining an input target vector;
removing a global offset value vector from the input target vector to form an offset target vector;
applying a global scale factor to the offset target vector to form a scaled offset target vector;
transforming the scaled offset target vector to a target discrete cosine transform search domain to form the DCT target vector.

22-24. (canceled)

25. The encoder of claim 19, wherein performing the sub-optimal pairwise inner search comprises:
for each segment of the plurality of segments, initializing a segment pair to a value large enough to ensure that both values in the segment pair will be updated;
for each vector index in each segment:
determining if a mean square error, MSE, of the vector index being analyzed is smaller than a MSE of the segment pair;
responsive to the MSE of the vector index being smaller than the worst MSE of the segment pair, updating the pairwise initial candidate set to include the vector index;
responsive to the MSE of the current vector being smaller than the best MSE of the segment pair, updating the segment pair to include the vector index.

26. The encoder of claim 19, wherein performing post optimization on the plurality of pairwise initial candidates comprises:
determining which pairwise initial candidate of the plurality of pairwise initial candidates has a lowest mean square error, MSE, of the plurality of pairwise initial candidates;
for each pairwise initial candidate other than the pairwise initial candidate with the lowest MSE:
comparing a MSE of the pairwise initial candidate to a MSE of a neighbor vector in a forward direction;
responsive to the MSE of the pairwise initial candidate being higher than the MSE of the neighbor vector in the forward direction, updating the pairwise initial candidate to the neighbor vector in the forward direction;
responsive to the pairwise initial candidate updated to the neighbor vector in the forward direction has a lower MSE than the pairwise initial candidate with the lowest MSE, setting the pairwise initial candidate updated to the neighbor vector in the forward direction as the pairwise candidate having a lowest MSE;
comparing the MSE of the pairwise initial candidate to a MSE of a neighbor vector in a reverse direction;
responsive to the MSE of the pairwise initial candidate is higher than the MSE of the neighbor vector in a reverse direction, updating the pairwise initial candidate to the neighbor vector in the reverse direction;
responsive to the pairwise initial candidate updated to the neighbor vector in the reverse direction has a lower MSE than the pairwise initial candidate with the lowest MSE, setting the pairwise initial candidate updated to the neighbor vector in the reverse direction as the pairwise candidate having a lowest MSE.

27-29. (canceled)

30. The encoder of claim 19, wherein reconstructing the plurality of pairwise final candidates comprises:
obtaining an index, idx_full, in a range of [0 . . . (Nv−1)] that contains a plurality of segments in a range of 0 to Ns−1 and corresponding column shift values;
performing a segment and coefficient wise upshift of the plurality of segments using the column shift values for the index to form upshifted segments;
performing an inverse discrete cosine transform, DCT, Type II transform of the upshifted segments;
scaling an output vector from the inverse DCT Type II transform to an original unscaled FDCNG domain vector; and
adding a global offset value vector back to the unscaled frequency domain-comfort noise generation, FD-CNG, domain vector to form a fdcng_final_{idx_full} vector.

31. The encoder of claim 19, wherein the truncated vectors include vector segments having different degrees of high frequency content as compared to other segments.

32. The encoder of claim 19, wherein the final candidate data includes one or more of vector indices, reconstructed candidate vectors, and/or transformed codebook entries.

33. The encoder of claim 19, further being adapted to perform post optimization on the plurality of pairwise initial candidates to replace a plurality of the plurality of pairwise initial candidates using a list of candidate neighbors to thereby form a plurality of final candidates.

34-39. (canceled)
